(19) United States
(12) Patent Application Publication
(10) Pub. No.: US 2007/0127887 A1
(43) Pub. Date: Jun. 7, 2007

(54) Digital video recorder enhanced features

(76) Inventors: Adrian Yap, Gaithersburg, MD (US); Michael Ficco, Silver Spring, MD (US)

Correspondence Address: THE DIRECTV GROUP INC, PATENT DOCKET ADMINISTRATION RE/R11/A109, P O BOX 956, EL SEGUNDO, CA, 90245-0956, US

(21) Appl. No.: 11/699,675

(22) Filed: Jan. 30, 2007

Related U.S. Application Data
(62) Division of application No. 10/022,094, filed on Dec. 17, 2001.
Application No. 10/022,094 is a continuation-in-part of application No. 09/836,378, filed on Apr. 17, 2001.
Application No. 09/836,378 is a continuation-in-part of application No. 09/766,252, filed on Jan. 19, 2001, now abandoned.
Application No. 09/766,252 is a continuation-in-part of application No. 09/533,843, filed on Mar. 23, 2000, now abandoned.

(51) Int. Cl. H04N 7/00

(52) U.S. Cl. 386/95

(57) ABSTRACT

A method and device for performing enhanced recording, editing and management features for content in a communication system. The device may be a set top box (STB) for example, and preferably a STB equipped with digital video recording (DVR) capabilities. The method offers users an ability to select, record and manipulate desired program content using mutually exclusive menus, or directly from an electronic program guide (EPG). This is done by displaying various parameter menus of selectable parameters for recording operations, so as to select one or more parameters via a suitable user interface in order to effect a desired recording feature or function.

### CROSS REFERENCE TO RELATED CASES

This application is a continuation-in-part and claims benefit under 35 U.S.C. § 120 to U.S. Non-Provisional application of Michael Ficco et al. entitled “DVR System”, Ser. No. 09/836,378, filed on Apr. 17, 2001, which is a continuation-in-part and claims benefit under 35 U.S.C. §120 to U.S. Non-Provisional application of Doug Dillon et al., entitled “Personal Video On-Demand System and Method”, Ser. No. 09/766,252, filed on Jan. 19, 2001, which is a continuation-in-part and claims benefit under 35 U.S.C. §120 to U.S. Non-Provisional application of Michael Ficco et al. entitled “Personal Video On-Demand System and Method”, Ser. No. 09/533,843 filed on Mar. 23, 2000, the entire contents of each application being incorporated by reference herein. This application also claims benefit under 35 U.S.C. §119(e) to U.S. Provisional application of Adrian Yap et al. entitled “Digital Video Recorder Enhanced Features”, Ser. No.: 60/311,789, filed on Aug. 10, 2001, the entire contents of which is also incorporated by reference herein.

### BACKGROUND OF THE INVENTION

1. Field of the Invention

This invention generally relates to recording devices in communication systems. More particularly, the present invention is directed to enhanced applications and features related to digital recording devices in communications systems having a set top box (STB) equipped with a digital video recorder (DVR).

2. Description of Related Art

Conventional communications systems may include a receiver for receiving and processing transmitted waveforms. For example, in a satellite communications system, the receiver may include a small satellite dish connected by a cable to a set-top box (STB) or an integrated receiver-decoder (IRD), which are used as interchangeable terms in the art. The satellite dish is aimed toward the satellites, and the STB is connected to the user's television in a similar fashion to a conventional cable-TV decoder.

A micro-controller controls the overall operation of the STB, including the selection of parameters, the set-up and. control of components, channel selection, viewer access to different programming packages, blocking certain channels, and many other functions. The compression and decompression of packetized video signals may be accomplished according to the Motion Picture Expert Group (MPEG) standards and the compression and decompression of audio signals may be accomplished according to the Motion Picture Expert Group (MPEG) standards, DOLBY DIGITAL (or AC-3) standards, DTS or other known standards. The conventional STB also typically includes video and audio decoders in order to decompress the received compressed video and audio. The STB may output video and audio data to a number of destinations, including audio and video decoders, ports, memories, and interface devices, such as a digital VHS (DVHS) interface. The STB may send the same audio and video data to different destinations.

Recently, due to the advances in digital technology and with a goal of creating greater personalized television for viewers, the STB has become embodied as part of a digital VCR (DVCR) an/or digital VHS (DVHS) receiver for example, in the continuing development of digital video recording devices. These devices incorporate a host of both traditional and powerful new features. For example, these features may include high quality digital A/V, the ability to pause/rewind live video and/or audio programs as they are broadcast, multi-speed fast forward and fast rewind, instant replay, slow motion and frame by frame advance. Additionally, the viewer may have access to, and have the ability to manipulate or develop an electronic program guide of listings.

Such digital video recording devices allow sports fans and movie buffs alike to have full control of live television programs and sporting events in full digital-quality. Viewers may also be able to create customized programming by searching for, and recording, programs that match their preferences by actor, director, keyword or any combination of content searches. Combined with the wide variety of program selections, viewers may find exactly what they are looking for and even create their own “TV channels” based on their favorite programming.

The electronic program guides (EPG) generally may be displayed as a menu on a screen of a TV for example. Operation of push buttons or keys of a remote control may display a series of menu screens having an array of cells corresponding to particular programming events, channels, TV programs, etc. The viewer may scroll through the cells to choose a particular program, pull up another sub menu to find out more information on a particular program, or pull up a sub menu with additional options.

However, none of these recent digital video recording devices envision certain system parameters, features, functions and/or enhancements which enable users to cut-and-paste segments from multiple recordings to form a new program, which support live caching of content until a storage device of the digital video recording device is out of space, or which enable selection of desired program trailers from a preview channel that will be recorded when the selected program(s) are broadcast in their entirety, for example. Accordingly, there is a need for enhanced features that are automatically, or by user direction, displayed on a display device to allow the viewer to efficiently perform certain operational functions or applications with the digital video recording device.

### SUMMARY OF THE INVENTION

The present invention provides a method and device for performing recording, editing and management of content in a communication system. The device may be a set top box (STB) for example, and preferably a STB equipped with digital video recording (DVR) capabilities. The method offers users an ability to select, record and manipulate desired program content from an electronic program guide (EPG). This is done by displaying a parameter menu of selectable parameters for recording, so as to select one or more parameters via a suitable user interface in order to effect a desired recording feature or function. Additional methods for recording, editing and managing content using enhanced features of the device are also described.

In one aspect of the invention, a “channel record” feature enables users to specify the channel of programs to be recorded. In another aspect, the STB is configured with an extended pause feature to support live caching (i.e., temporary buffering or storage) of content until a mass storage device such as a hard disk drive (HDD) is out of space. In a further aspect of the invention, an audio-video editing feature enables users to cut-and-paste segments from multiple recordings to form a new program. In yet a further aspect, a “record from preview” feature enables selection of desired program trailers from a preview channel that will be recorded when the selected program(s) are broadcast in their entirety.

As an additional enhancement, a “smart convert” feature enables multiple, cached, live programs to be converted to permanent recordings on a suitable mass storage device such as a HDD or other storage media. In yet a further aspect, an undelete feature permits users to recover previously deleted but not yet purged recorded programs.

Moreover, another feature of the present invention is the ability to record one program while pausing another program. In other words, the user may watch a first channel (which may be automatically spooled or cached to a suitable storage medium to enable the pause function) and simultaneously record a second channel.

Still further enhancements include a program listing such as a DVR Play List that enables users to select multiple recorded programs to be played on the device of the invention. Additionally, the present invention provides real-time graphical icons or objects that indicate current storage capacity and/or out-of-storage alerts that may be visual and or audio and visual.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, wherein like elements are represented by like reference numerals, which are given by way of illustration only and thus are not limitative of the present invention and wherein:

FIG. 1 is a block diagram of a personalized video-on-demand system according to a first aspect of the invention;

Fig.2 is a block diagram of a personalized video-on-demand system according to a second aspect of the invention;

FIG. 3 is a high-level flow chart of the inventive method of determining potentially desired content;

FIG. 4 is a high-level flow chart of a method of creating a video-on-demand service;

FIG. 5 is a high-level flow chart of a method of generating an electronic program guide according to the invention; and

FIG. 6 is a block diagram of an exemplary architecture in accordance with the present invention;

FIG. 7 is a block diagram showing an exemplary construction of a memory device according to an exemplary embodiment of the present invention;

FIGS. 8 and 9 illustrate exemplary recording and playback paths of the STB 300 in accordance with the invention;

FIG. 10 illustrates a partial block diagram of FIG. 6, so as to show an exemplary communication path between a remote control device 400 and STB 300;

FIG. 11 illustrates the data flow from command signal to display, for a parameter, data or menu associated with STB 300 in accordance with the present invention;

FIGS. 12(a) and 12(b) illustrate an enhanced feature in accordance with the invention;

FIG. 13 illustrates another enhanced feature in accordance with the invention;

FIG. 14 illustrates the extended pause process in accordance with the invention

FIG. 15 illustrates an exemplary method of A/V editing in accordance with the invention;

FIG. 16 illustrates an exemplary menu to convert multiple cached programs to permanently recorded programs;

FIG. 17 illustrates an exemplary menu display for an undelete feature in accordance with the invention; and

FIG. 18 illustrates a method of building and editing a DVR play list in accordance with the invention.

### DETAILED DESCRIPTION

The present invention provides a method and device for performing enhanced recording, editing and management features for content in a communication system. The device may be a set top box (STB) for example, and preferably a STB equipped with digital video recording (DVR) capabilities. The method offers users an ability to select, record and manipulate desired program content using mutually exclusive menus or directly from an electronic program guide (EPG). This is done by displaying various parameter menus of selectable parameters for recording, so as to select one or more parameters via a suitable user interface in order to effect a desired recording feature or function. Additional methods for recording, editing and managing content using enhanced features of the device are also described.

The present invention is preferably directed to a STB equipped with DVR, but is not limited to this configuration. The device and various processes may be embodied in a future DVR player or even as part of a IV/DVR. composite structure; embodied in networks of such hardware, satellite receivers, firmware, software, as part of a computer-readable or actuate-able medium within a processor or CPU of a PC for example, as part of physical, volatile memory such as RAM, SDRAM, VRAM, etc., and/or provided as individual ASICs or other circuit structures within the device.

The method and device of the invention take advantage of a virtually unlimited available storage capacity, as well as a substantial plurality of menu driven functions. In addition to being directed to an STB and or other devices set forth above, the device and method(s) of the invention are equally applicable to future cable TV/satellite video-on-demand (VOD) products produced by a wide variety of manufacturers.

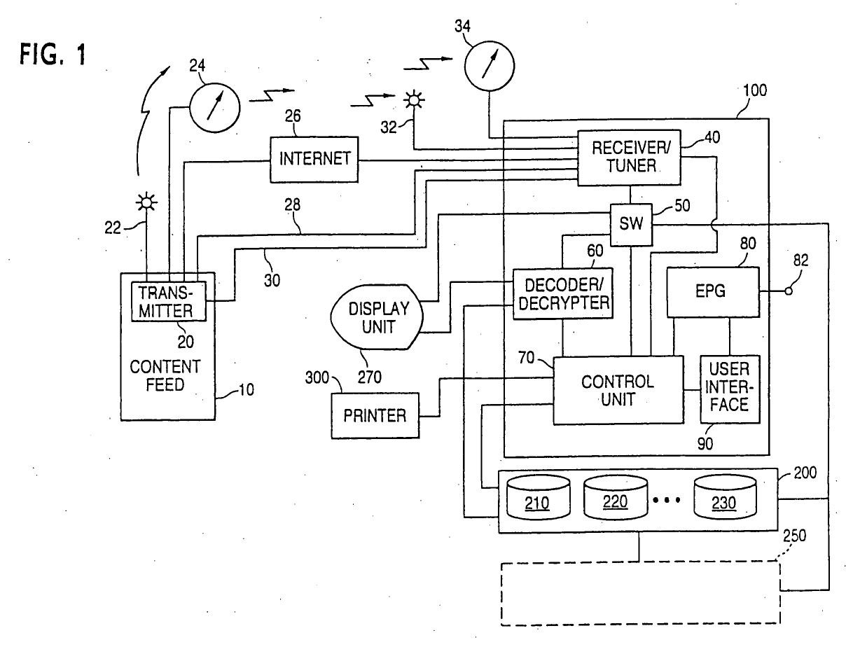

Before describing the various enhanced features of the present invention, the inventors in FIGS. 1 -11 initially provide an overview of an exemplary personalized video-on-demand system, exemplary system architecture, memory, recording paths and exemplary user-interface configurations applicable to the enhanced features, so as to provide context for the enhanced features to be described in accordance with the invention.

FIG. 1 illustrates an exemplary video-on-demand (VOD) system in accordance with the invention. As shown in FIG. 1, the personalized video-on-demand system includes a content feed 10. This content feed 10 may include a broadcast television network or internet content provider. The content feed is compatible with all cable, satellite and terrestrial broadcast television systems as indicated by transmitter 20 that is connected to a broadcast antenna 22, satellite up-link 24, internet connection 26, cable 28, and phone line 30. These various connections and standards are exemplary only and are intended to include any system for feeding content to a consumer.

On the consumer side, an apparatus 100 such as a set-top box, hardware card, specially programmed computer or other device having the functionality described herein is provided that may be placed near to or within a television or other display device (such as a computer monitor) such as display unit 270. The apparatus 100 inputs content from devices such as satellite down-link 34, antenna 32, internet connection 26, cable 28, and/or phone line 30. It is to be understood that the apparatus 100 may include just a single communication path including 26, 28, 30, 32, or 34.

The received content is fed to receiver/tuner 40. The receiver/tuner 40 provides an appropriate connection to the corresponding communication path. The receiver/tuner 40 may also select or tune a channel within the spectrum of content being fed to the apparatus 100. If there is only one channel, then the receiver unit 40 need not include a tuner circuit.

A switch 50 is connected to the receiver/tuner 40 and routes the content to display unit 270, decoder/decrypter 60, or storage device 200. The switch 50 is controlled by control unit 70 to route the content to the desired destination. For example, switch 50 may decode, decrypt, output to display unit 270, and/or record to a storage device and is not limited to performing only a single function at a given time.

The decoder/decrypter 60 includes decoder circuitry and/or decryption circuitry. For example, many video broadcasts are encoded and the decoder 60 decodes this encoded content stream so that it may be viewed by the consumer on display unit 270. Conventional decoding processes such as MPEG1 and MPEG2 are examples of such decoding processes.

The decoder/decrypter 60 may also include decryption circuitry that decrypts an encrypted content from the content feed. Some broadcasts, particularly pay-per-view broadcasts or premium channels such as HBO® and Showtime® are encrypted so that non-subscribers cannot view the content. The decrypter 60 decrypts any such encrypted content for viewing on the display unit 270 by the consumer. The decrypter may include a variety of decryption schemes for corresponding premium channels or services. As with conventional cable boxes, the decryption circuitry may be enabled or disabled depending upon the consumer's subscription to the premium channel or associated encrypted content. Authorization for decryption may be governed by appropriate payment for the associated content. For example, pay-per-view content is typically encrypted with decryption authorization governed by an appropriate payment by the consumer.

As a further alternative, the decrypted content may be stored for later purchase and playback. In this alternative, the consumer need not pay in advance or contemporaneous with the live broadcast and can, instead, store the encrypted content for later playback. Such delayed playback may also include an associated payment if required by the content provider by utilizing the user interface 90 and communication channel(s) with content feed 10 or by having the consumer contact the content provider using other communication channels and payment mechanisms.

The component 60 may also implement an encryption scheme separate from and/or in addition to the encryption scheme utilized by the content feed 10. In other words, encrypted content supplied from content feed may be further encrypted to further protect unauthorized access to the content.

The electronic program guide (EPG) 80 is connected to an input port 82 so that updates to the electronic program guide may be downloaded. In other words, the electronic program guide stores available content for the near future. This available content may be updated on a periodic basis so that the consumer can make appropriate selection for upcoming programs. The electronic program guide 80 preferably displays information on the display unit 270. For example, the electronic program guide 80 may display programs in a tabular format by channel and time so that the user can make selections of desired content. Other examples and functionality of the electronic program guide 80 are described below.

The user interface 90 may include various control devices such as a keypad connected directly to the apparatus 100 or a remote control device. The user interface 90 permits the user to interact with the apparatus 100 and electronic program guide 80 and thereby select content for recording and on-demand playback.

The storage device 200 is connected to the switch 50 as well as the control unit 70 and the decoder/decrypter 60. The storage device 200 may also be directly connected to the display unit 270. The storage device 200 may include a plurality of hard disk drives 210, 220, 230 as shown in FIG. 1. Also, the storage device 200 may include only one hard disk drive although the storage capacity would be necessarily limited by the capacity of the single hard disk drive 210.

Preferably, the storage device may be expanded by plugging in additional hard disk drives such as hard disk drive 220 as well as hard disk drive 230. Preferably, adding storage capacity could be easily accomplished by the user by simply plugging in a storage device such as a hard disc drive. The collection of hard disk drives 210, 220 . . . 230 may also be considered a hard disk drive array. Such an array may use conventional data loss prevention methods such as error correcting codes, and Redundant Array of Independent Discs (RAID) methodologies.

The storage device 200 may be further expanded by adding an optional array of hard disk drives 250 as shown by the dotted lines in FIG. 1. The storage devices 200, 250 may be provided in a separate unit from apparatus 100.

Alternatively, the storage device 200 may include other types of storage devices. For example, the storage device may include solid state memory devices such as chips, cards, or sticks. The storage device may also include magnetic tape, magnetic or optical disk (for example, a read/write disk or a write once/read many disk), CD, DVD, a portable digital audio/video/data player, a jukebox, or any other known or not yet invented form of storage.

The storage device further may be reconfigurable, including, as examples, expandable, addable, removable, and/or replaceable. The storage device may be manually reconfigurable or automatically reconfigurable. For example, a user may replace all or part of the storage device. Alternatively, the storage device may be configured as a “juke-box” including a plurality of memory devices 210, 220, 230 (either of the same or different types), which are automatically loaded for recording or playback, possibly based on a user initiated request.

The memory devices 210, 200, 230 may be integrated with the storage device 200 and/or the apparatus 100 or accessible via a network (either local or wide-area) utilizing a transfer protocol (for example, the 1394 protocol) or a combination of integrated and removable memory. Preferably, the memory devices 210, 220, 230 may be plugged in or otherwise expanded with a modular design. This modular design is indicated in FIG. 1 by the plurality of storage devices 210, 220,230 as well as the additional array of storage devices 250. Such a modular design permits a user to easily increase the storage capacity and thereby the size of the video-on-demand library.

The control unit is connected to the storage devices 200, 250, the decoder/decrypter 60, the switch 50, the receiving device 40, the electronic program guide 80, as well as the user interface 90.

In general, the control unit 70 coordinates all of the operations performed by the apparatus 100 by sending appropriate control signals to each of the various components. For example, when the electronic program guide indicates that the desired content will appear on channel 7 at 8:00 pm, the control unit 70 sends a control signal to receiver/tuner 40 to tune channel 7 at 8:00 pm, then control unit 70 sends a control signal to control switch 50 to switch the tuned content and output the tuned content to the storage device 200. The control unit 70 also controls the recording of this content on the storage device 200. For example, the control unit 70 may synchronize the sending/receiving of data between the storage device 200 and the control unit 70, in order to avoid periods of inaccessibility. For example, if one of the memory devices 210, 220, 230 is being removed or otherwise not available, the control unit 70 controls via synchronization, recording and/or playback, such that during the period of inaccessibility, the memory device 210, 220, 230 is not accessed. The control unit 70 may accomplish synchronization by sending a sync pulse to a storage device 200 and/or memory devices 210, 220, 230, in order to coordinate the availability of the memory devices 210, 220, and 230, with the operation desired by the control unit 70.

Additionally, any necessary decoding or decryption is controlled by control unit 70 which sends commands to the decoder/decrypter the output of which is sent to display unit 270. The control unit 70 may also be utilized to control the rate at which information is recorded or played back. For example, the control unit 70 may record on a first medium, for example an internal medium, in real time, and then stream the information to a removable medium, either faster or slower than real time, depending on the capabilities of the removable medium. Similarly, the control unit 70 may permit the playback of information from either an internal or external memory, either faster or slower than real time, and subsequently output the data for playback in real time. The control unit 70 may utilize one or more medium to vary the rate at which content is either played back or recorded by utilizing at least one medium as a buffer.

The control unit 70 also coordinates the operations between the user interface 90 and the electronic program guide 80. For example, the on-demand playback of previously recorded content may be controlled with the user interface 90 by having the consumer input a command. This command is input by the control unit 70. For example, a play previously-recorded content command may be input by user interface 90. This command is sent to control unit 70 which activates the storage device 200 to read the corresponding content from the storage device 200. Any necessary decoding is then performed by decoder 60 under the control of control unit 70 the results of which are output to display unit 270.

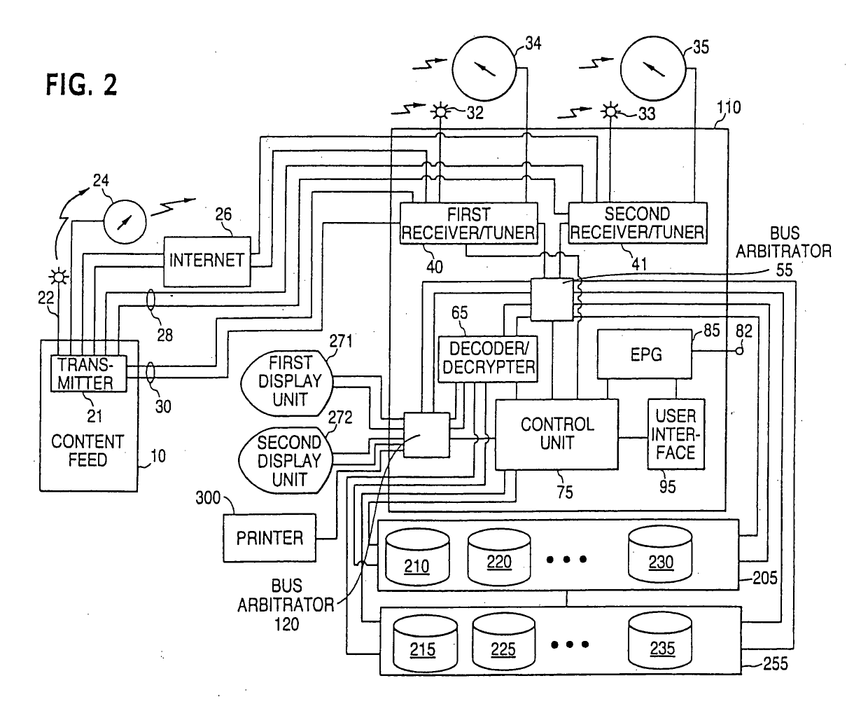

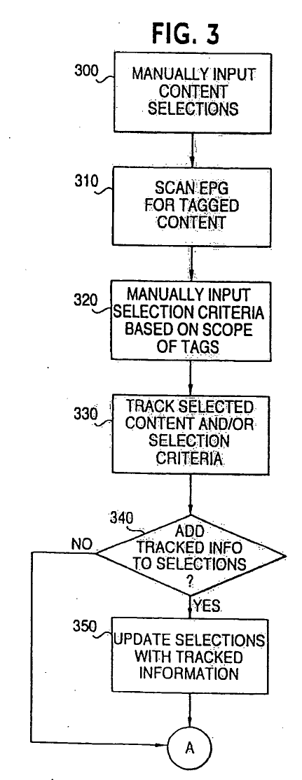

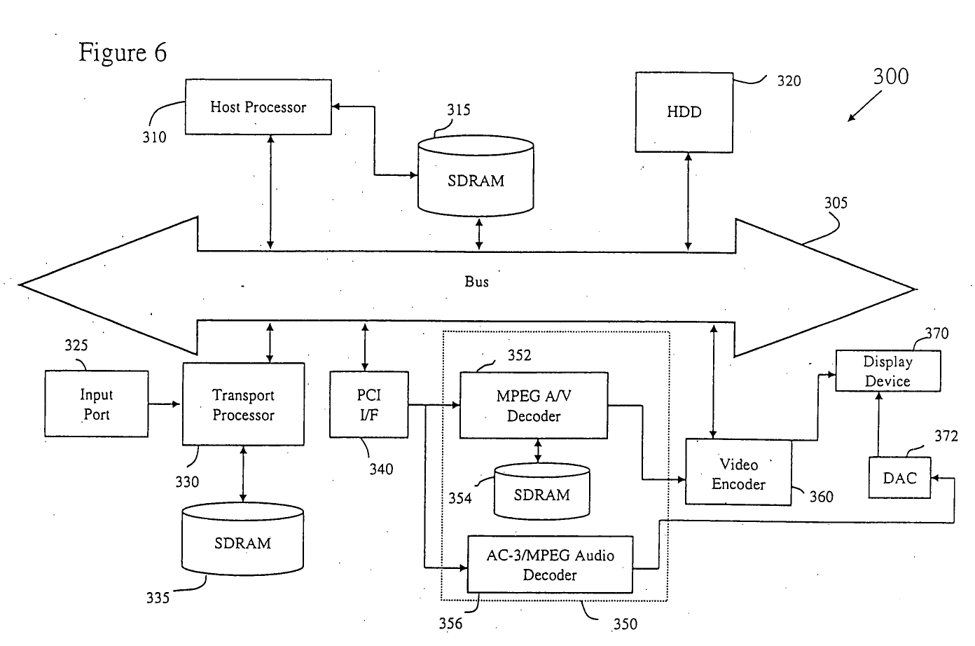

Although the system operates generally as described above, further details of the operation including both the provider and consumer side of the system are described below in relation to the flow charts of FIGS. 3-5. The block diagram of FIG. 6 further describes the operation of the system shown in FIG. 2.

FIG. 3 illustrates a particular example of how the FIG. 1 personal video-on-demand system operates. Specifically, FIG. 3 provides details on how the electronic program guide 80 interacts with the system.

As shown in FIG. 3, the consumer can manually input content selections in step 300. This may be done with the user interface 90. To aid in this process, the electronic program guide 80 may send a display to display unit 270 that aids in the manual input of content selections. In this way, the consumer can designate or otherwise select certain programs or other content to be recorded in the video-on-demand library. Step 300 may also delete previously selected content. In this way, the list of content selections may be tailored to the user's preferences.

Enhancing the electronic program guide 80 are tags. A tag includes data that is associated with or otherwise describes content. For example, a tag may indicate which actors are in a particular movie, the director of the movie, a synopsis of the movie, when it was released, critical reviews of the movie, related programs, sequels, keywords, a thumbnail, a preview, a snippet, or other information concerning or relating to the content. The tags may be in-band or otherwise transmitted along with the content. Alternatively, the tags may be associated with the program or otherwise sent separately such as with an electronic program guide.

Step 310 scans the electronic program guide 80 for content that has been tagged. In other words, step 310 searches or scans through the electronic program guide 80 for any content that has an associated tag. Step 320 allows the user to manually input selection criteria. These selection criteria are preferably based on the scope of the tags. In other words, if the tags are limited to actors and actresses, then the selection criteria may be similarly limited since other criteria would not effect the content selection. In this way, the user can manually input one or more selection criteria in order to search for desired content. This search may return a list or group of programs all of which may be recorded or which may be provided to the user for selection where only the selected content is recorded. This selection may be done by repeating step 300.

To further enhance the electronic program guide, step 330 tracks selected content and/or selection criteria. In other words, previously selected content may be tracked or otherwise stored by the control unit by the storage device 200. Also, previously input selection criteria may also be tracked or otherwise stored by the control unit 70 in the storage device 200. By tracking selected content and/or selection criteria, the electronic program guide 80 may learn the user's preferences and thereby speed the content selection process.

However, the consumer may not desire this tracking to be utilized. Thus, step 340 decides whether the consumer wants to add the tracked information to the selection. This may be done, for example, by prompting the user and inputting a command via the user interface 90. As another option, a default option may be utilized to make the decision of step 340.

If the tracked information is to be added to the selections, then step 350 is performed which updates the selections with the tracked information. In this way, a variety of content selections appropriate to and personalized to the consumer can be generated. The selection may be further managed by rearranging, deleting or by adding further selection by repeating the process shown in FIG. 3. The selection(s) may be presented to the user for modification(s). Alternatively, the system may simply retrieve the selections without user modification(s) to the selection(s).

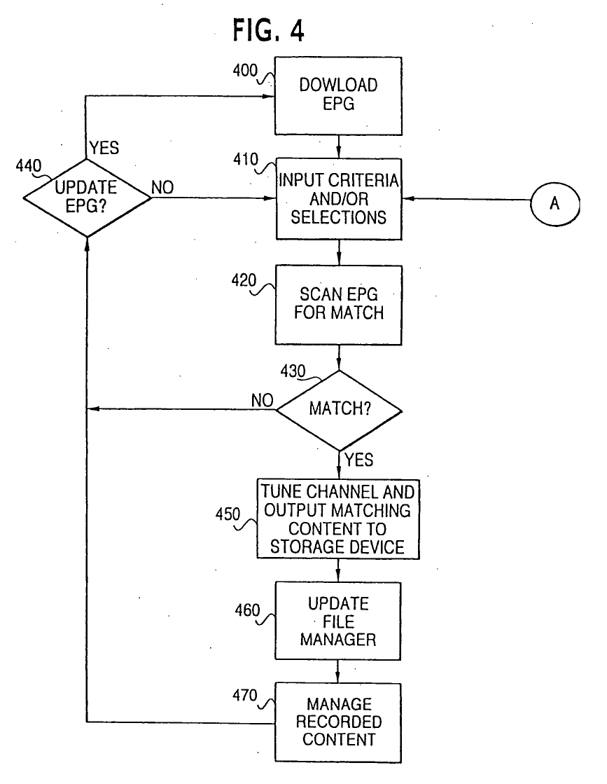

FIG. 4 illustrates further details of how the personalized video-on-demand system of FIG. 1 operates. This process begins in step 400 by downloading the electronic program guide 80. This may be done by utilizing port 82. For example, port 82 may be connected to a telephone line, cable connection, satellite up-link, or radio broadcast antenna. Using any or all of these methods, the information in the electronic program guide 80 may be down-loaded by step 400.

Step 410 then inputs criteria and/or selection(s). This process is described above in relation to FIG. 3 as indicated by connector A. In other words, the FIG. 3 process ends with connector point A which connects this process to the process of FIG. 4.

With the criteria and/or content selection in hand, step 420 can then scan the electronic program guide 80 for matches. In other words, the available content within the electronic program guide 80 is scanned for content matching the user's selections and/or criteria.

Step 430 then determines whether there is a match between the consumer selections and/or criteria and the electronic program guide 80. If there is no match, then the process may continue by proceeding to step 440 which decides whether to update the electronic program guide 80. Preferably, the electronic program guide 80 is updated on a periodic basis. For example, it may be most convenient to update the electronic program guide during off-peak hours. By tracking the user's viewing habits, the system can determine when these off-peak hours occur so that the downloading of the electronic program guide can occur when the consumer is not watching TV. If the electronic program guide 80 is to be updated, then the process proceeds to step 400 which downloads the electronic program guide 80. If not, then the process returns to the input step 410 which inputs the consumer's selections and/or criteria.

If there is a match between the consumer's selections and/or criteria, then the flow proceeds to step 450 which tunes the channel and/or otherwise outputs the matching content to the storage device. For example, the control unit 70 controls the receiver/tuner 40 to tune the channel of the available content spectrum to the appropriate channel. Then, the switch 50 is controlled by control unit 70 to switch the tuned channel to be fed to the storage device 200. The storage device 200 may then record the routed content.

Once the content has been recorded by storage device 200, step 460 then updates a file manager that may be part of the storage device 250 , the control unit 70, other elements of the apparatus 100, or a separate entity. Essentially, the recorded content is stored as a file or files within the storage device 200. These file(s) have an associated address or header information that is managed by the file manager. Step 460 updates the file manager with information related to the recorded content.

By using the file manager, the user can then manage the recorded content with step 470. Specifically, the managing of the recorded content includes sorting, cataloging, adding comments, deleting, reorganizing, etc. Such management may also include on-demand playback. Such playback includes various commands including play, rewind, fast forward, pause, slow, skip, etc. in a manner similar to a video cassette recorder. It is noted that a VCR is given only by way of example, and any other device capable of the functions described above or similar functions, is also within the scope of the present invention.

The file manager may manage the recorded content by maintaining a data base, containing an entry for each recorded item. The entry may describe the content recorded and identify the memory device (either removable or not) which contains the recorded content. The entry may include all or part of the information received from the electronic program guide. The information received from the electronic program guide may be automatically entered. The entry may also be supplemented by notes or images from the user. The entry may contain alphanumeric characters, images, or both. The file manager may also forward the entry information to the printer 300, either directly from the storage device 200 or via the apparatus 100 (for example, the control unit 70) so that the entry information is printed on a label that can be affixed to the memory device. The file manager may also prompt the user, via user interface 90, to place a self-stick adhesive label in the printer 300.

The user may interface with the file manager via a graphical user interface (GUI), as is known in the art. The GUI allows the user to see what content is available. The GUI also indicates to the user where the content is stored, so the user can manually load the proper medium. As discussed above, alternatively the storage device 200 could automatically load the proper media by using a jukebox arrangement, for example.

As is apparent from the above, the database may be populated with information stored in the memory internal to the apparatus 100 or the storage device 200, as well as pre-recorded, removable media, for example, conventional DVDs. It is also possible that user-recorded content, which is stored in the memory internal to the apparatus 100 or the storage device 200, could be saved on removable media. In the instance, it may be advantageous to compress or modify compression parameters to improve the storage efficiency on the removable media. Generally, the apparatus 100 permits the copying or moving of content from internal, non-removable memory to external, removable memory, and vice versa.

The apparatus 100 also supports transcoding from one medium type to another to ensure efficient storage on the target medium. One such example is an initial, user-initiated request to record. The content may be recorded in internal, non-removable memory using one compression technique or set of compression parameters and recorded to an external, removable memory using a different compression technique or set of compression parameters, to thereby improve the storage efficiency of each memory type. In the context of the present specification, the term transcoding or coding is used to identify any type of compression, encryption, reformatting or other manipulation of the information to customize the information for the particular medium on which it is to be stored. After managing the recorded content in step 470, the flow then proceeds to step 440 which decides whether to update the electronic program guide 80 as described in detail above.

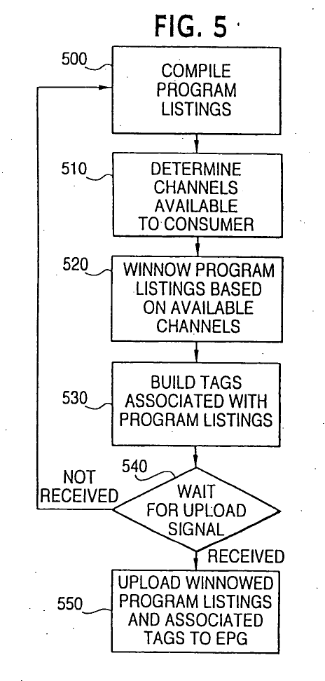

As shown in FIG. 5, the inventive methods also include building the electronic program guide. This process may start with step 500 which compiles the program listings. Such program listings include a channel line-up, names of programs, station information., descriptions of programs, and other information.

Next, step 510 determines which channels are available to the particular consumer. As there are a variety of broadcast systems throughout the world, the channel line-up is different for different consumers. Furthermore, consumers have a choice of broadcast system(s) from which to choose which affects the channels available to the consumer. Step 510 selects from the full spectrum of program listings those channels that are available to the consumer.

Step 520 then winnows the program listings based on the available channels. In other words, the data from step 510 is utilized to winnow the program listings to those that are available to the particular consumer.

Step 530 then builds tags that are associated with the program listings. The tags are described above and will not be repeated here. Step 530 gathers information to build the tags and associates the tags with the program listings.

Then, the system waits for an upload signal. If it has not been received, then the process leaps back to step 500. For example, more information may be available to build or supplement the tags. Also, more channels or less channels may be available to the consumer. All of these considerations are accounted for by looping through steps 500 through 540 until the upload signal has been received.

When the upload signal has been received, then the uploading process begins. Step 550 uploads the winnowed program listings and associated tags to the electronic program guide.

Although FIG. 5 is primarily directed to processes performed by the content feed 10, much of this process could alternatively performed on the consumer side by the apparatus 100. More specifically, the determination of the channels available to the consumer (step 510) and the winnowing of program listings based on available channels (step 520) may be performed on the consumer side by apparatus 100, in one example, by the control unit 70 working in conjunction with the electronic program guide 80 and the storage device 200. In this alternative, the content feed 10 would supply all program listings to the apparatus 100 for determination by the apparatus 100 of the available channels and winnowing of the program listings based on available channels.

As a further alternative, the tag building step 530 may also be performed by the apparatus 100. For example, the control unit 70 may utilize the various communication channels 26, 28, 30, 32 and/or 34 to gather information appropriate for the tags. These tags may then be associated with the corresponding program and stored in the electronic program guide.

The upload signal may be sent by the control unit to the content feed at a specific time, random time, or on command of the user via user interface 90. As mentioned above, it would be most convenient to update the electronic program guide during off-peak hours. By tracking the user's viewing habits, the system can determine when these off-peak hours occur so that the downloading of the electronic program guide can occur when the consumer is not watching TV.

FIG. 2 illustrates an alternative embodiment of the personalized video-on-demand system. This alternative of FIG. 2 is specifically designed for reception/tuning of plural programs, simultaneous recording of two or more programs, as well as simultaneously recording one program while viewing or playing back another program.

Many elements from the first embodiment of FIG. 1 are also utilized in FIG. 2. Common or like reference numerals indicate similar devices and functionality. The FIG. 2 embodiment supports all features described above in conjunction with the FIG. 1 embodiment. Additional features are emphasized below.

The transmitter 21 of content feed 10 is capable of transmitting a plurality of content streams. As further shown in FIG. 2, there are at least two connections each provided to the internet 26, cable 28 and telephone lines 30. Furthermore, the transmitter 22 is capable of broadcasting two or more content streams. Likewise, the satellite up-link 24 is also capable of transmitting two or more content streams.

On the receiving end, the apparatus 110 includes inputs from a first satellite down-link 34 as well as a second satellite down-link 35. These satellite down-links may be integrated into. a single satellite down-link having two feeds. In addition, two antennas 32, 33 are utilized. Alternatively, a single connection (satellite down-link, cable, telephone, or internet or antenna) having a split feed could also be utilized instead of the two connections described above. In other words, the connections may be configured to transmit/receive more than one content stream.

As further shown in FIG. 2, the apparatus 110 includes two receivers, specifically receiver/tuner 40 and receiver/tuner 41 which are connected the various communication devices as shown.

The output from receiver/tuners 40, 41 are provided to bus arbitrator 55. Bus arbitrator 55 outputs to bus arbitrator 120 as well as decoder/decrypter 65, storage device 205 and storage device 255. In this way, either or both of the inputs from receivers 40, 41 can be routed to bus arbitrator 120, decoder/decrypter 65, and/or storage devices 205, 255.

The decoder/decrypter 65 receives inputs from bus arbitrator 55 as well as storage devices 205, 255. The outputs of the decoder/decrypter are provided to the bus arbitrator 120.

Bus arbitrator 120 receives inputs from bus arbitrator 55 and decoder/decrypter 65. The output of bus arbitrator 120 is provided to first display unit 271 and second display unit 272.

The decoder/decrypter 65 is similar to the decoder/decrypter 60 of the FIG. 1 embodiment, with the main difference being that decoder/decrypter 65 is capable of handling a plurality of content streams. In other words, the decoder/decrypter 65 may simultaneously decode and/or decrypt more than one content stream.

The electronic program guide 85 is connected to the control unit 75, the user interface 95 and an input port 82. The electronic program guide (EPG) 85 is similar to the electronic program guide (EPG) 80 of the first embodiment except that the EPG 85 may handle a plurality of content streams. For example, the EPG 85 may be a combination of two EPGs 80.

Similarly, the user interface 95 permits the user to enter commands for both of the content streams rather than the single content stream handled by the first embodiment of FIG. 1.

The control unit 75 has control outputs to the receiver/tuners 40, 41; the bus arbitrator 55; the decoder/decrypter 65; the EPG 85; the user interface 95; the bus arbitrator 120; and the storage devices 205, 255.

The storage device 205 is similar to storage device 200 of the first embodiment, but is preferably equipped with a plurality of read/write units. In other words, a storage device 205 is preferably capable of simultaneously recording and/or playing back at least two programs.

An optional, second storage device 255 may also be provided as further shown in FIG. 2. This optional second storage device is connected to the first storage device 205 as well as to bus arbitrator 55 and decoder/decrypter 65.

The storage devices 205, 255 are preferably modular units that can be expanded by adding additional units therein. For example, if hard disk drives are used for the storage devices 205, 255 then the storage capacity can be expanded by adding additional hard disk drive units. Also, the same variety of storage media may be utilized for the storage devices 205, 255 as described in relation to the storage device 200, 250 of the first embodiment.

FIG. 6 illustrates an exemplary architecture of an STB 300 envisioned for the enhanced features of the present invention. The STB 300 utilizes a bus 305 to interconnect various components and to provide a pathway for data and control signals.

STB 300 includes a host processor 310, a memory device 315 (in an exemplary configuration embodied as an SDRAM 315) and a hard disc drive (HDD) 320 connected to the bus 305. In this embodiment, the host processor 310 may also have a direct connection to SDRAM 315 as shown in FIG. 3 (i.e., such that SDRAM 315 is associated as the memory for host processor 310). Although memory device 315 is described as SDRAM 315 hereinafter in the present application, memory devices of EDO RAM (extended data output DRAM), BEDO RAM (Burst EDO RAM), RLDRAM by Rambus, Inc., SLDRAM by the SyncLink Consortium, VRAM (video RAM), or any other known or developing memory that is writeable may be sufficient as memory device 315.

As further shown in FIG. 6, a transport processor 330 and PCI I/F 340 (peripheral component interconnect interface) are connected to the bus 305. The transport processor 330 also has a connection to input port 325 and SDRAM 335. SDRAM 335 has the same attributes as SDRAM 315 and may be replaced with any of the other above-noted alternative memory devices. Furthermore, the PCI I/F 340 is connected to a decoder 350. The decoder 350 is connected to a video encoder 360. The output of video encoder 360 is in turn sent to a display device 370. Decoder 350 may include both an MPEG A/V decoder 352 and an AC-3/MPEG audio decoder 356, the output of the latter being sent to display device 370 after conversion in a digital-to-analog converter (DAC) 372.

The host processor 310 may be constructed with conventional microprocessors such as the currently available PENTIUM processors from Intel. Host processor 310 performs non real-time functions in the STB 300, such as graphical-user interface and browser functions. A browser is a software engine that presents the interface to, and interacts with, a user of the STB 300. The browser is responsible for formatting and displaying user-interface components and pictures. Typically, the user interface is displayed as a Graphical User Interface (GUI).

Browsers are often controlled and commanded by the standard HTML language, which is used to position and format the GUI. Additionally, or in the alternative, any decisions and control flow of the GUI that requires more detailed user interaction may be implemented using JavaScript™. Both of these languages may be customized or adapted for the specific details of a given STB 300 implementation, and images may be displayed in the browser using well known JPG, GIF and other standardized compression schemes. It is noted that other non-standardized languages and compression schemes may be used for the browser and GUI, such as XML, “home-brew” languages or other known non-standardized languages and schemes.

HDD 320 is actually a specific example of a mass storage device. In other words, the HDD 320 may be replaced with other mass storage devices as is generally known in the art, such as known magnetic and/or optical storage devices, (i.e., embodied as RAM, a recordable CD, a flash card, memory stick, etc.). In an exemplary configuration, HDD 320 may have a capacity of at least about 40 Gbytes or more, where preferably about at least 35 Gbytes is available for various recording applications, and the remainder flexibly allocated for pause applications in STB 300.

The bus 305 may be implemented with conventional bus architectures such as a peripheral component interconnect (PCI) bus that is standard in many computer architectures. Alternative bus architectures such as VMEBUS from Motorola, NUBUS, address data bus, RAM bus, DDR (double data rate) bus, etc., could of course be utilized to implement bus 305.

The transport processor 330 performs real-time functions and operations such as control of the A/V data flow, conditional access, program guide control, etc., and may be constructed with an ASIC (application specific integrated circuit) that contains, for example, a general purpose R3000A MIPS RISC core, with sufficient on-chip instruction cache and data cache memory. Furthermore, the transport processor 330 may integrate system peripherals such as interrupt, timer, and memory controllers on-chip, including ROM, SDRAM, DMA controllers; a packet processor, crypto-logic, PCI compliant PC port, and parallel inputs and outputs.

The implementation shown in FIG. 6 actually shows the SDRAM 335 as being separate from the transport processor 330, it being understood that the SDRAM 335 may be dispensed with altogether or consolidated with SDRAM 315. In other words, the SDRAMs 315 and 335 need not be separate devices and can be consolidated into a single SDRAM or other memory device.

The input port 325 receives audiovisual bitstreams that may include, for example, MPEG-1 and MPEG-2 video bitstreams, MPEG-1 layer II audio bitstreams and DOLBY DIGITAL (AC-3) audio bitstreams. Exemplary A/V bitrates may range from about 60 Kbps to 15 Mbps for MPEG video, from about 56-384 Kbps for MPEG audio, and between about 32-640 Kbps for AC-3 audio. The single-stream maximum bitrate for STB 300 may correspond to the maximum bitrate of the input programming, for example 16 Mbps or 2 MBps, which corresponds to the maximum MPEG-2 video bitrate of 15 Mbps, maximum MPEG-1 Layer-2 audio bitrate of 384 kbps, and maximum AC-3 bitrate of 640 kbps.

Any audio or video formats known to one of ordinary skill in the art could be utilized. Although FIG. 6 has been described in conjunction with digital television, the signal supplied could be any type of television signal, any type of audio or video data, or any downloadable digital information. Of course, various other audiovisual bitstream formats and encoding techniques may be utilized in recording. For example, STB 300 may record an AC-3 bitstream, if AC-3 broadcast is present, along with MPEG-1 digital audio. Still further, the received audiovisual data may be encrypted and encoded or not encrypted and encoded. If the audiovisual data input via the input port 325 to the transport processor 330 is encrypted, then the transport processor 330 may perform decryption. Moreover, the decryption may be performed instead by the host processor 310.

Alternatively, the host processor 310 and transport processor 330 may be integrated or otherwise replaced with a single processor. As mentioned above, the SDRAMs (315 and 335) may be consolidated or replaced with a single SDRAM or single memory device.

The PCI I/F 340 may be constructed with an ASIC that controls data reads from memory. Audiovisual (A/V) data may be sent to the host processor 310's memory (SDRAM 315) while simultaneously being sent to an MPEG A/V decoder 352, as further discussed below.

Decoder 350 may be constructed as shown in FIG. 3 by including the MPEG A/V decoder 352 connected to the PCI I/F 340, as well as an AC-3/MPEG audio decoder 356 which is also connected to the PCI I/F 340. In this way, the video and audio bitstreams from the PCI I/F 340 can be separately decoded by decoders 352 and 356, respectively. Alternatively, a consolidated decoder may be utilized that decodes both video and audio bitstreams together. The encoding techniques are not limited to MPEG and AC-3, of course, and can include any known or future developed encoding technique. In a corresponding manner, the decoder 350 could be constructed to process the selected encoding technique(s) utilized by the particular implementation desired.

In order to more efficiently decode the MPEG bitstream, the MPEG A/V decoder 352 may also include a memory device such as SDRAM 354 connected thereto. This SDRAM 354 may be eliminated, consolidated with decoder 352 or consolidated with the other SDRAMs 315 and/or 335. SDRAM 354 has the same attributes as SDRAM 315 and 335, and may be replaced with any of the other above-noted alternative memory devices.

Video encoder 360 is preferably an NTSC encoder that encodes, or converts the digital video output from decoder 350 into a coded analog signal for display. Regarding the specifications of the NTSC (National Television Standards Committee) encoder 360, the NTSC is responsible for setting television and video standards in the United States. The NTSC standard for television defines a composite video signal with a refresh rate of 60 half-frames (interlaced) per second. Each frame contains 525 lines and can contain 16 million different colors.

In Europe and the rest of the world, the dominant television standards are PAL (Phase Alternating Line) and SECAM (Sequential Color with Memory). Whereas NTSC delivers 525 lines of resolution at 60 half-frames per second, PAL delivers 625 lines at 50 half-frames per second. Many video adapters or encoders that enable computer monitors to be used as television screens support both NTSC and PAL signals. SECAM uses the same bandwidth as PAL but transmits the color information sequentially. SECAM runs on 625 lines/frame.

Thus, although use of a video encoder 360 is envisioned to encode the processed video for display on display device 370, the present invention is not limited to the NTSC standard encoder. PAL and SECAM encoders may also be utilized. Further, hi-definition television (HDTV) encoders may also be viable to encode the processed video for display on a HDTV, for example.

Display device 370 may be an analog or digital output device capable of handling a digital, decoded output from the video encoder 360. If analog output device(s) are desired, to listen to the output of the AC-3/MPEG audio decoder 356, a digital-to-analog converter (DAC) 372 is connected to the decoder 350. The output from DAC 372 is an analog sound output to display device 370, which may be a conventional television, computer monitor screen, portable display device or other display devices which are known and used in the art. If the output of the AC-3/MPEG audio decoder 356 is to be decoded by an external audio component, a digital audio output interface (not shown) may be included between the AC-3/MPEG audio decoder 356 and display device 370. The interface may be a standard interface known in the art such as a SPDIF audio output interface, for example, and may be used with, or in place of DAC 372, depending on whether the output devices are analog and/or digital display devices.

The video output from video encoder 360 and/or audio output from audio decoder 356 or DAC 372 does not necessarily have to be sent to display device 370. Alternatively, encoded A/V data may be output to external devices or systems operatively connected to the STB 300, such an off-broadcast system, cable TV system or other known systems which can reproduce the encoded audio and/or video signals for reproduction and/or display. This may also include a PC that can play video or audio files containing the encoded A/V data sent from the STB 300, for example.

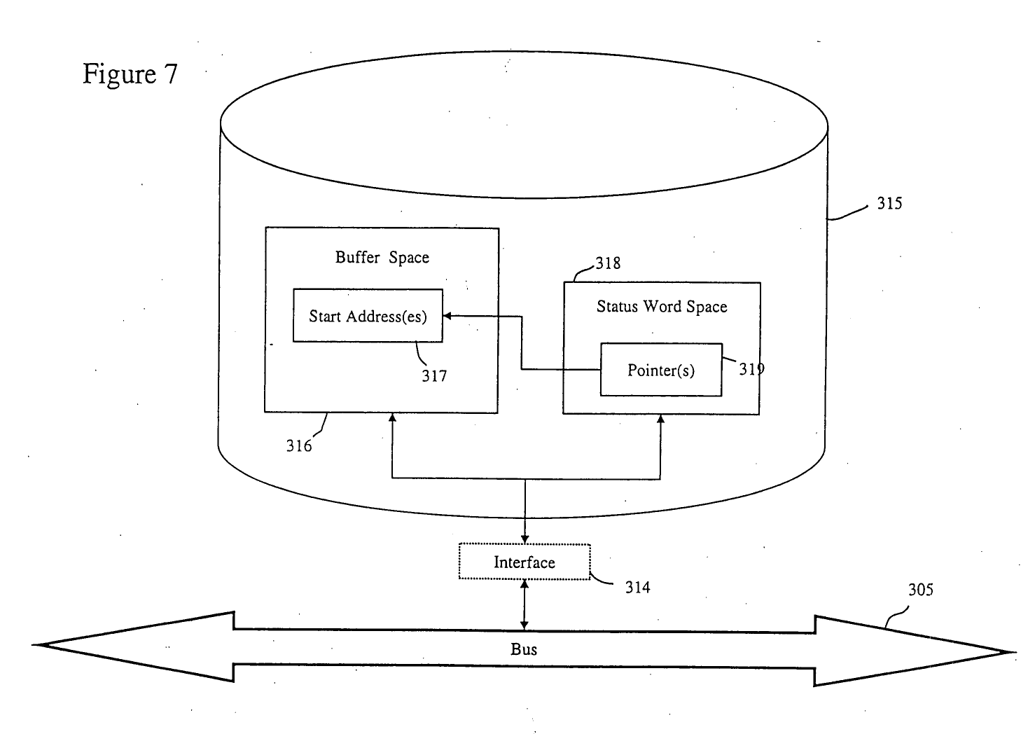

FIG. 7 illustrates various components that may be provided for the SDRAM 315. As mentioned above, the SDRAM shown in FIG. 6 is actually a specific implementation of a memory device. It is noted that the invention is not limited to this specific implementation of SDRAM 315 and can include any other known or future developed memory technology. Regardless of the technology selected, the memory device 315 may include a buffer space 316 which may be a fixed or virtual set of memory locations that buffers or otherwise temporarily stores audiovisual data. In practice, the video data may be stored separate from the audio data, but it would be possible to intermix these data types depending upon the particular application and coding techniques utilized for the audio and visual data.

The audio visual data stored in the buffer space 316 includes one or more start addresses 317 which indicate the beginning memory address at which the audio and/or video data (A/V) is stored. If the A/V data is separately stored, then a plurality of stored addresses will be necessary. Furthermore, if there is more than one set of, or a block of data within the buffer space 316, then the start addresses 317 will individually point to each block of data.

The memory device 315 also includes a status word space 318. This status word space includes fixed or virtual addresses at which status words may be stored. An example of a status word that may be stored in the status word space 318 is a status word summarizing the status of a peripheral device. For example, the status word that may be stored within the status word space 318 may include the status of the host processor 310 or transport processor 330. The status word space 318 may also include pointers 319 that point to the start addresses 317 within the buffer space 316.

As further shown in FIG. 7, the SDRAM 315 may connect to the bus 305 via an interface 314. The dash lines indicate that the interface 314 is optional and may or may not be included depending upon the interface requirements of the particular memory device 315 and/or bus 305.

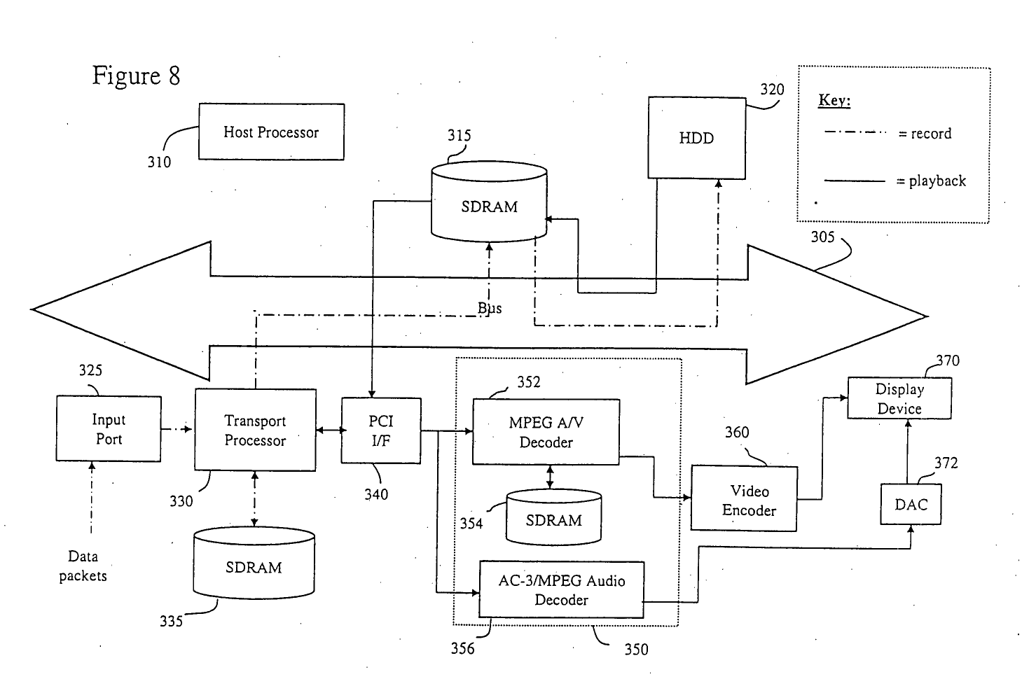

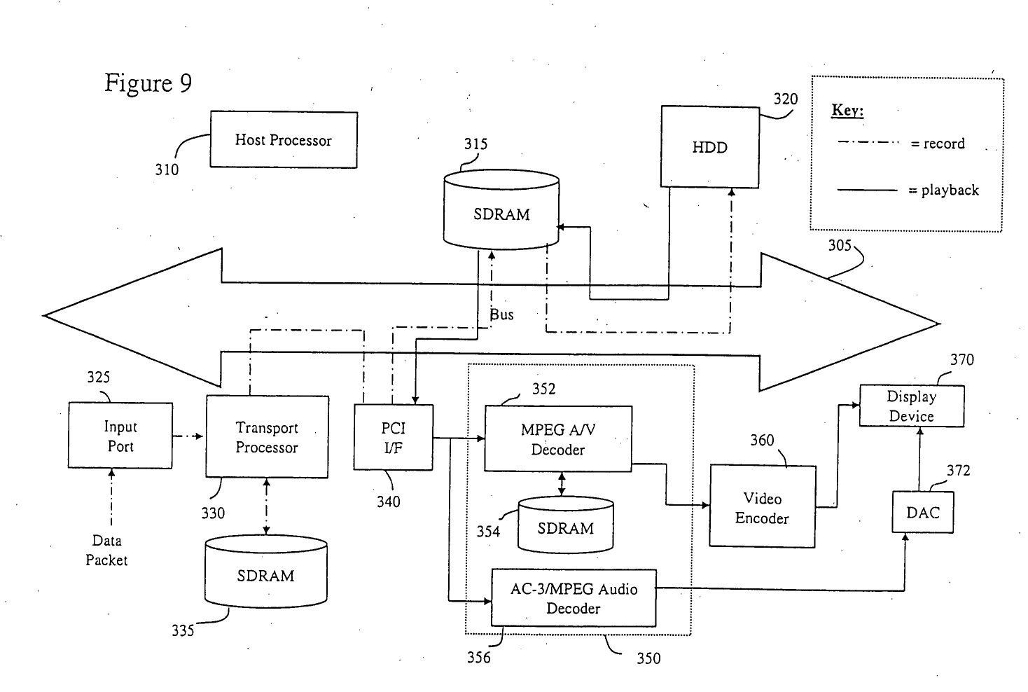

The recording and playback paths of the STB 300 are described in accordance with FIGS. 8 and 9. FIG. 8 shows the recording and playback data flows among the various components of the STB 300. Some of the connections between components, and associated reference numerals from FIG. 6 may have been eliminated in FIGS. 8 and 9 in order to highlight the data flow which is shown using dashed lines (see Key) in FIGS. 8 and 9.

As shown in FIG. 8, A/V data of selected content (e.g., a selected or desired event, program and/or broadcast) is received by input port 325 (typically the data is received in packetized and encrypted form) and fed to the transport processor 330. The transport processor 330 then transfers the received A/V data to SDRAM 315. Digital recording is accomplished by the host processor 310, which transfers the A/V data buffered by SDRAM 315 to the HDD 320. In other words, the SDRAM 315 serves as a buffer that buffers data sent by transport processor 330. This allows the host processor 310 to control the recording onto the HDD 320 when host processor 310 time is available. When a sufficient amount of programming data has been accumulated in the SDRAM 315, the host processor 310 transfers the data from the SDRAM 315 to the HDD 320 for recording therein.

FIG. 9 illustrates an alternative signal path for recording. Audiovisual data is fed from the input port 325 to the transport processor 330. The transport processor 330 then transfers the received audiovisual data to the PCI I/F 340, as indicated by the dashed data flow line. The PCI I/F 340 receives audiovisual data from the transport processor 330 via bus 305, and sends this data to host processor 310, more particularly to SDRAM 315.

Digital recording is accomplished similarly, with SDRAM 315 serving as a buffer that buffers data sent by the PCI I/F 340. This allows the host processor 310 to control the recording onto the HDD 320 when processor time is available. When a sufficient amount of A/V data has been accumulated in the SDRAM 315, the host processor 310 transfers the data from the SDRAM 315 to the HDD 320 for recording therein. To record data, the host processor 310 may also inform the PCI I/F 340 of available start addresses in the SDRAM buffer space 315 to which data may be buffered for eventual recording in HDD 320.

The operation of playing back the recorded A/V data that represents stored content (e.g., a stored event, program, broadcast, etc.) in STB 300 is now described. Referring again to FIG. 8, when the viewer turns the STB 300 on, the viewer is given the option to playback any of the previously recorded programs, events, broadcast, etc. This may be done, for example, by using a remote control or other suitable user command interface (not shown) to access a menu on display device 370. If the viewer selects a desired event, the corresponding A/V data (which typically may also include system time and conditional access packets) are retrieved from HDD 320.

In particular, when the user selects the playback option, the selected A/V data recorded on HDD 320 is sent via bus 305 to a queue in SDRAM 315. Next, the buffered data is sent from SDRAM 315 via bus 305 to transport processor 330, back to bus 305 and then to PCI I/F 340, which in turn sends the selected A/V data to decoder 350. More specifically, the video portion of the bitstream is sent to MPEG A/V decoder 352, with the audio portion being sent to AC-3/MPEG audio decoder 356.

Within decoder 350, MPEG A/V decoder 352 may be provided with an SDRAM 354 in order to more efficiently decode the MPEG bitstream received from PCI I/F 340. SDRAM 354 is similar to SDRAM 315 discussed above in its construction. SDRAM 354 temporarily holds the encoded video bitstream data, and also provides the three frame buffers required for MPEG decoding, as is known in the art. Thereafter, the decoded A/V data is output to video encoder 360 for conversion to an analog format, so that it may be displayed on display device 370. From this point on, the playback data looks, for all intents and purposes, identical to the originally recorded event, program, broadcast, etc.

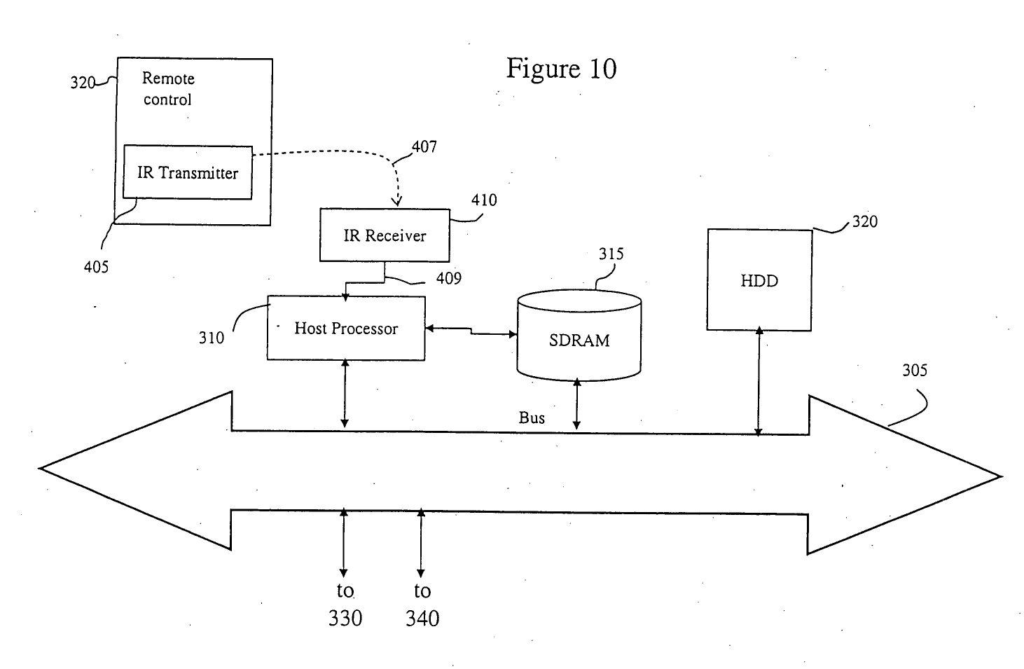

FIG. 10 illustrates a partial block diagram of FIG. 6, so as to show an exemplary communication path between a remote control device 400 (not shown in FIG. 8) and the host processor 310 of STB 300. In FIG. 10, there is illustrated a remote control device 400 which is in. communication with the host processor 310 in order to send commands for operating features, functions and/or to display menus associated with STB 300 operation and functionality on display device 370 for example. The remote control device may be a device that is specific to the STB 300, and/or may be a universal remote control device which controls various individual components connected within a home entertainment system (TV, stereo, tape deck, DVD player, CD player, STB, etc.)

As is well known in the art, the remote control device 400 may include a remote control transmitter 405 therein for transmitting various key or pushbutton-associated signals (commands) selected by the viewer or user to perform certain functions, to display certain parameters or data associated with the STB 300. These are sent in the form of an infrared (IR) ray signal 407 for example, to the STB 300, and in particular to an IR receiver 410 that may be operatively connected to host processor 310. IR receiver 410 decodes the received infrared ray signal 407, such as by photoelectric conversion for example, and sends a system drive signal 409 (which is preferably a digital signal) to host processor 310. The host processor 310 thus analyzes the composed code information (i.e., the command data generated by the user) corresponding to the received system drive signal 409. This may be a command to display a desired parameter, menu or user-interface feature of the STB 300, for example.

Although the above communication path and user interface to the STB 300 are explained with regard to using a remote control device, commands and/or processing necessary to display parameters may also be initiated by a user actuating buttons, switches and/or keys that may be provided on, or integral with STB 300 and/or an external keypad or PC operatively connected to STB 300. Moreover, these buttons, switches and/or keys may interact with software or package programs within STB 300 (i.e., provided within SDRAM 315, HDD 320 or as part of host processor 310) in order to effect display of a desired parameter, feature, function, display, etc. on a screen of a device. These alternative interfaces provide redundancy for the viewer, as well as alternative means to display parameters, menus or functions of STB 300 on a display device 370.

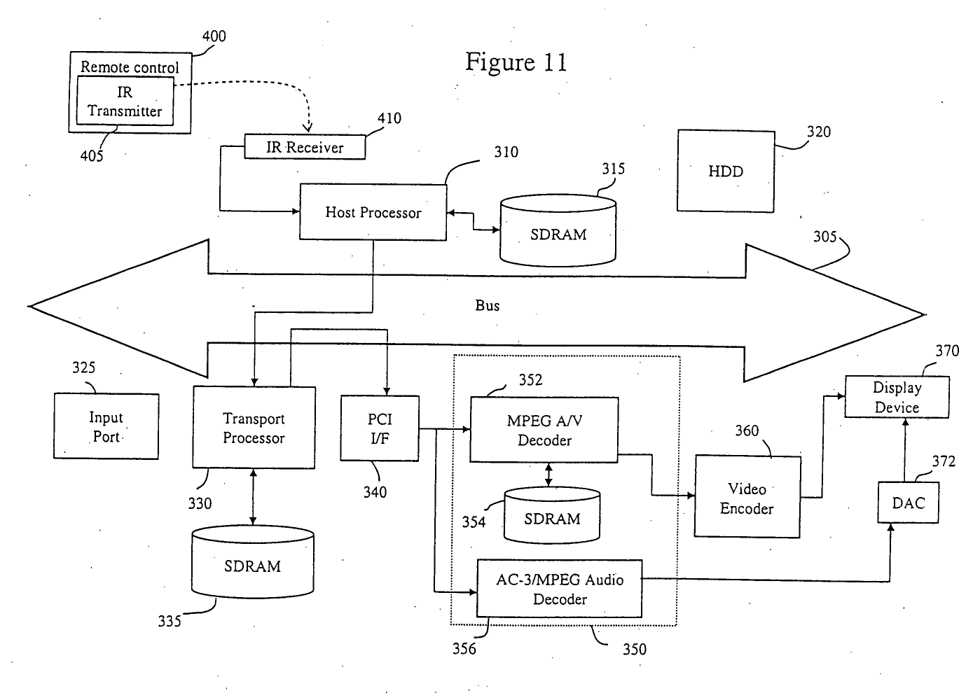

FIG. 11 illustrates the data flow from command signal to display, for a parameter, data or menu associated with STB 300 in accordance with the present invention. A plurality of parameters or data, such as data for specific menus or displayable features, etc., are stored in HDD 320. Additionally, certain ones of these stored parameters may be updated to reflect current status of STB 300. This may be done, for example, by using designated software programs or predetermined algorithms within host processor 310.

The host processor 310 receives an IR ray signal (i.e., a command) from remote control device 400 that is converted into a digital signal. This signal may be a command directing that a certain parameter, menu or data associated with STB 300 may be displayed. Thus, host processor 310 retrieves the ordered data from HDD 320 via SDRAM 315, where it is buffered temporarily after being sent from HDD 320, so that the data may be processed by host processor 310.

Host processor 310 sends the selected data (i.e., digitized voice, digitized A/V, digital text, etc.) corresponding to the desired parameter, menu or function via bus 305 as a A/V data stream to PCI I/F 340, which in turn sends the selected data to decoder 350. From this point, the flow path is identical to that for playback described initially in FIG. 6. The decoded A/V data stream is output to GA 360/AC-3/MPEG audio decoder 356; or directly to MPEG A/V decoder 352 for conversion to an analog format as required, so that the desired parameter may be displayed on display device 370.

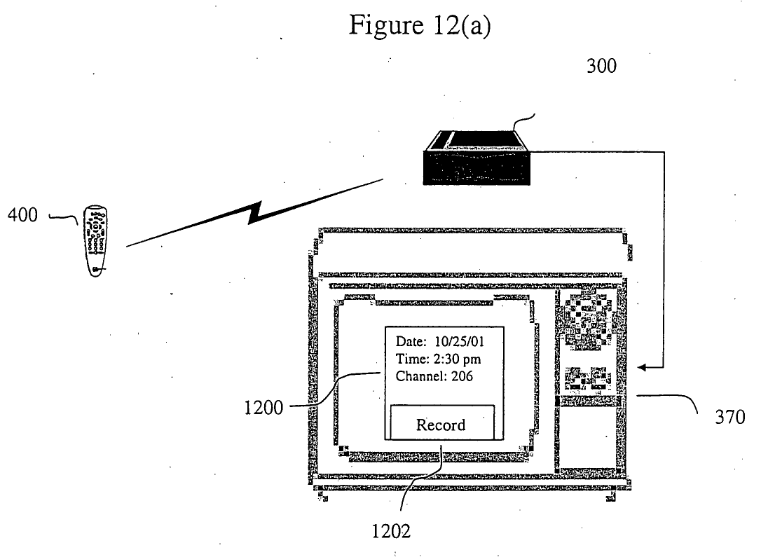

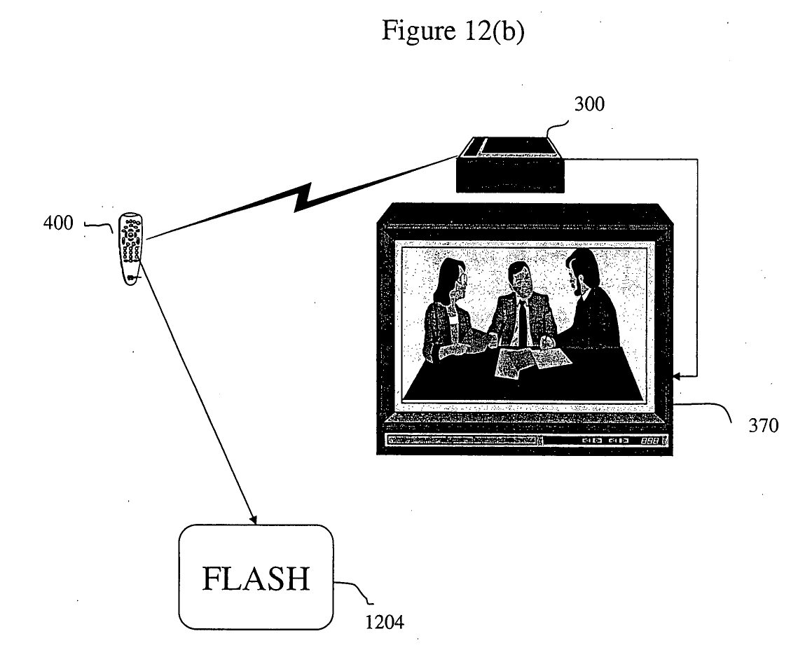

The system(s) and architecture having now been explained, the enhanced features in accordance with the invention are now described with reference to FIGS. 12-18.

FIG. 12(a) and 12(b) illustrate an enhanced feature in accordance with the invention. Referring to FIG. 12(a), a user, via a suitable user interface such as remote control 400, displays a small pop-up menu 1200 on display device 370 prompting certain channel data. This menu preferably is displayed by pressing an action button on the remote control 400 to send a command to host processor 310 within STB 300, but may also be displayed by pressing an action button on the STB 300, or accessed from a main menu of recording options displayed on STB 300 (not shown). The user enters the date, time and channel for recording and then selects an execution cell 1202, here entitled “Record”. As shown in FIG. 12(a), for example, date: Aug. 25, 2001, start record: 2:30 pm, channel: 206 (or enters the name of the channel, such as ESPN). At 2:30 pm on the specified date, the recording begins, and continues until HDD 320 is out of space or until the specified recording duration is achieved.

In a variation of this feature, while watching a particular channel, a user may begin immediately recording, e.g., “impulse record” to a suitable mass storage device such as HDD 320. To do so, and as shown in FIG. 12(b), the user depresses a “flash” button 1204 (shown in exploded view) on a suitable user-interface, such as remote control 400. The flash button provides a one-touch command to the STB 300, sending a command which tells the host processor 310 to begin recording the currently viewed channel immediately, and to continue recording until the user sends another command to stop recording. This may be effected by pressing the flash button 1204 again to display a prompt such as “stop recording channel 206?” together with a yes/no cell on display device 370 for the user to select, until the HDD 320 runs out of disk space, or preferably when the program ends. This feature allows the user to record content from that point in time forward, or alternatively can record content from the beginning of the program.

In another variation, the user is able to manipulate or review the displayed EPG data to check for time conflicts between programs and to select alternate tuners for the STB. For example, this could be embodied as a pop-up alert icon on the display device 370 or superimposed over EPG 80. This alert could notify the user that another program is to be recorded at that time.

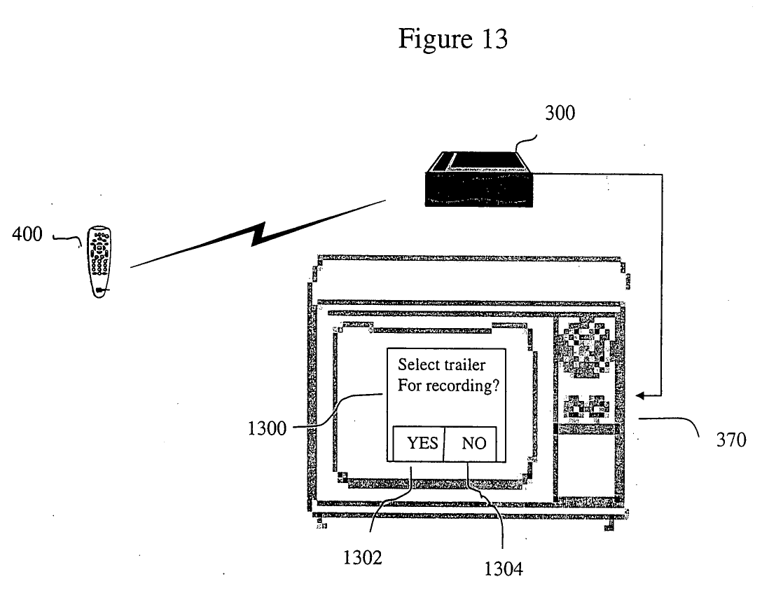

FIG. 13 illustrates another enhanced feature in accordance with the invention. Referring to FIG. 13, the user has an option to display a preview channel of selectable content. The selectable content on the preview channel represents a plurality of broadcast trailers of a full-featured program or broadcast. Specifically, while watching trailers of these programs in this preview channel, a user selects trailers of which the corresponding program or content is desired to be recorded by STB 300 by pressing a button on a suitable user-interface such as remote control 400, keyboard, PC, etc., for example while watching a particular trailer.

A pop-up screen 1300 may automatically appear, prompting the user with language such as “Select trailer for recording?” and the user confirms by selecting one of YES cell 1302 or NO cell 1304, preferably using scroll keys on the remote control 400 and then pressing an execute button when the desired cell 1302 or 1304 is highlighted. Additionally, the user can access and display pop-up menus (not shown) for recording conflict identification for file management purposes, finding alternate tuners and handling pay-per-view issues. Preferably, these subordinate menus are automatically displayed after the user selects the YES cell 1302 in FIG. 13.

Alternatively, the user can access a sub-menu and select desired trailers which have been buffered in a suitable storage device such as SDRAM 315, HDD 320, external storage, etc. Once the desired trailers have been selected, recording will automatically commence when the programs corresponding to the selected trailers are broadcast in their entirety.

Further, the user can configure electronic program guide (EPG) 80, which is controlled by host processor 310 and displayed on display device 370 via remote control 400, for example, so that triggers and other identifying information may be embedded in the broadcast trailers. Specifically, these triggers may be pre-configured preferences such as watchwords (actor's name, team, etc.) that might be in a particular broadcast trailer, In other words, the electronic program guide 80 might program titles of trailers in a tabular format by channel and time, based on host processor 310 identifying a trigger in a particular trailer. Thus, the user can make selections of desired content by selecting a trailer, upon which the pop-up menu 1300 is displayed.

In another aspect, the STB 300 is configured to support live caching until a mass storage device such as a hard disk drive (HDD) is out of space by utilizing an “extended pause” feature. This extended pause enhanced feature provides the ability to channel hop without losing any potential programming for recording. The extended pause feature is user-configurable; it can be set on or off via a suitable display menu. Alternately, the default can be set to automatically on, with the extended pause feature being performed as a low-priority background process, without user intervention. Live broadcast is displayed during extended pause. A channel change will not erase any of the previously cached programs.

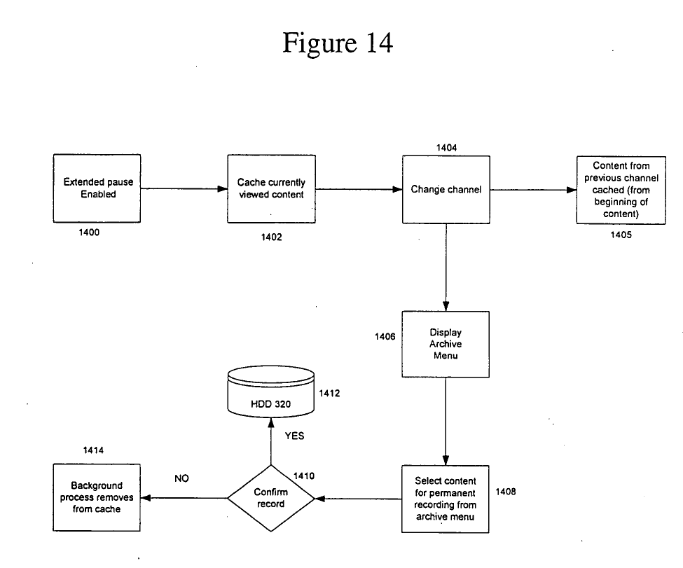

FIG. 14 illustrates the extended pause process. After the extended pause feature is enabled (user-selected to be ON or set ON as default) in step 1400, a user views a particular program. This program, event or broadcast at step 1402 is automatically buffered or cached temporarily in storage (SDRAM 315 for example) back to the beginning of the broadcast. Accordingly, the user does not have to view a program at the beginning in order to have the entire program available for recording. Next, in step 1404, a channel change is effected. Changing the channel does not erase the buffered programming from the previous channel as the extended pause feature, through background processes (step 1405) run by host processor 310, continues to buffer the programming from the previous channel. Thus, live programming can be viewed while the extended pause feature is enabled.

These background processes are essentially low-priority and are run to access the storage medium (SDRAM 315 for example) on which the buffered programming is stored. The background processing can add programming that has recently being viewed, and remove buffered programming that was viewed at some time in the past but which has yet to be selected for permanent storage, so as not to burden HDD 320 or the processing capacity of host processor 310. Such background processes are described in co-pending U.S. application (Ser. No. unknown, Atty. Dkt. No. PD-201139) to Michael Ficco et al., entitled “Method and System for Electronic Program Guide Temporal Content Organization”, the content of which is hereby incorporated by reference in its entirety.

To select buffered programs for recording, the user displays an archive menu in step 1406, which may be effected by scrolling through a main extended pause menu with a suitable user-interface, for example or displayed as a selectable function in EPG 80. This menu displays the buffered programming by channel, program, etc. that has been archived in storage while the user has been watching the display device 370 with extended pause enabled. The display may be in tabular form and may display the day's buffered programming, a specific time period (several hours), and/or a specific past day, depending on the available storage capacity.

The user can therefore select the recent and/or current program(s) desired for permanent recording (Step 1408) on a suitable mass storage device such as HDD 320, and confirms selection by highlighting a confirmation cell (Step 1410) on display device 370. Thereafter, if confirmation is YES, content or program temporarily cached or buffered are sent to HDD 320 from host processor 310 for permanent storage (step 1412) and/or indexing in an EPG 80 database stored on HDD 320, for example. If confirmation is NO, background processes prune (remove) the cached content from storage (step 1414).

Accordingly, the extended pause feature enables a complete archive of the user's viewing to be displayed, selected programs from which may be stored in any of SDRAM 315, HDD 320, or another separate/external storage device operatively connected to STB 300. This extended pause feature is therefore only limited to the available cache or buffer capacity available, and is envisioned for recording devices having very large hard drives, at least as large as what is currently available today; preferably able to store hundreds or even thousands of selectable content for permanent recording. Moreover, this feature is applicable to recording devices employing hard drive arrays, to future bulk storage technology, and also to recording devices having multiple tuners allowing passive (no user intervention needed) acquisition and storage of a substantial number of channels (in upward of 100 to even 900+ channels). Further, this feature is envisioned to record content off of all transponders communicating with STB 300, utilizing the aforementioned background processes to add and pare programming as needed to avoid burdening the storage and processing capabilities of STB 300.

File management is also possible utilizing the extended pause feature. The user may selectively add, delete and/or edit programs within the extended pause feature. Preferably, this is effected via a menu-driven feature. Further, the user may display a complete archive of those programs subject to extended pause.

In a further aspect of the invention, an audio-video (A/V) editing feature enables users to cut-and-paste segments from multiple recordings to form a new program. Specifically, the user, via remote control 400, GUI in host processor 310, keyboard, PC, etc., or by manipulating buttons directly on STB 300, can cut-and-paste segments from multiple recordings to form a new program. Moreover with this feature, the user can create a customized summary (i.e., highlights) of recorded programs. This feature is also applicable to programs cached using the extended pause feature .

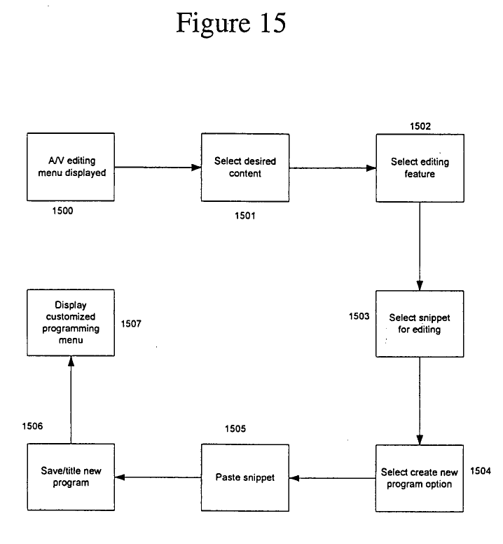

FIG. 15 illustrates an exemplary method of A/V editing in accordance with the invention. Initially, the user may access EPG 80 or display a separate pop-up A/V editing menu which includes a tabular listing of recorded (or cached) programs (step 1500). Next, the. user highlights a particular program (1501) and selects the editing feature (step 1502). This allows the user to scroll thru the selected, recorded program to search for a snippet to cut-and-paste. The user selects the snippet for editing (step 1503) and then selects a create new program option (step 1504), where the user can paste the snippet (step 1505) to form a new program. This may be a customized program for viewing, a video greeting card to friends, outgoing message (OGM) to be sent to designated entities, etc. Once the user creates a new program, the user then saves the program under a suitable title (step 1506), where it is stored in HDD 320, to be accessed by the user displaying a customized programming menu (step 1507) when access is desired.

As noted, the A/V editing feature is applicable to both permanently stored programs as well as cached programming. The A/V editing feature envisions graphical manipulation such as concatenation, truncation, frame capture, audio and video remix, etc. Additionally, combining the A/V editing and extended pause feature enables after-the-fact isolation and retention of programs desired by the user. For example, with the extend pause feature enabled, a cached program may be accessed and a snippet of that program captured and copied for incorporation into a desired customized program, greeting, etc., even where the cached program is eventually removed (not permanently recorded) from storage.

In a further enhanced feature in accordance with the invention, a “smart convert” feature enables multiple cached live programs to be converted to permanent recordings on a suitable mass storage device, such as a HDD, or on other storage media. For example, at a point where the HDD 320 is full and the extended pause feature has been enabled, there may be multiple programs cached using the extended pause feature. Accordingly, via a user-interface such as remote control 400, the user can select individual programs to be converted to permanent recording in HDD or other storage media.

Specifically, when STB 300 is powered up (turned on), an auto pause function is enabled, either by a default preset preference or via remote control 400, to automatically pause the currently-tuned channel. The user is then given the option to convert this paused program to a permanently recorded program, via a suitable pop-up menu, similar to what is shown in FIG. 12(a) for example.

Accordingly, to convert paused content to a recorded program, STB 300, via host processor 310 toggles a flag in order to convert cached programs to permanently recorded programs. Alternatively, an HDD 320 directory could be updated to re-allocate space such that the paused program now resides in a virtual recorded storage or memory location within HDD 320, under the control and direction of the host processor 310.

Alternatively, a channel surfing user who pauses a program and who, at some point within the pause window, decides that the program is worth permanently recording could, for example, press an “action” button on remote control 400 to command host processor 310 to permanently record the program to HDD 320, for example.

In another alternative, as the duration of the pause approaches the pause time window, such as 30 minutes for example, the user could be prompted with a menu-driven query such as “permanently record?” If yes, then the program is converted from a paused program to a permanently recorded program. In this way, the user does not lose any of the program that may have otherwise extended beyond the pause time window.

In a further alternative, any channel change from an exemplary channel #1 to and exemplary channel #2 converts paused channel #1 to recorded channel #1, begins pause of channel #2 and provides the user an option to “clear” recorded channel #1. This is described in greater detail in co-pending U.S. application Ser. No. 09/836,378, filed on Apr. 17, 2001 to Michael Ficco et al. and entitled “DVR System”.

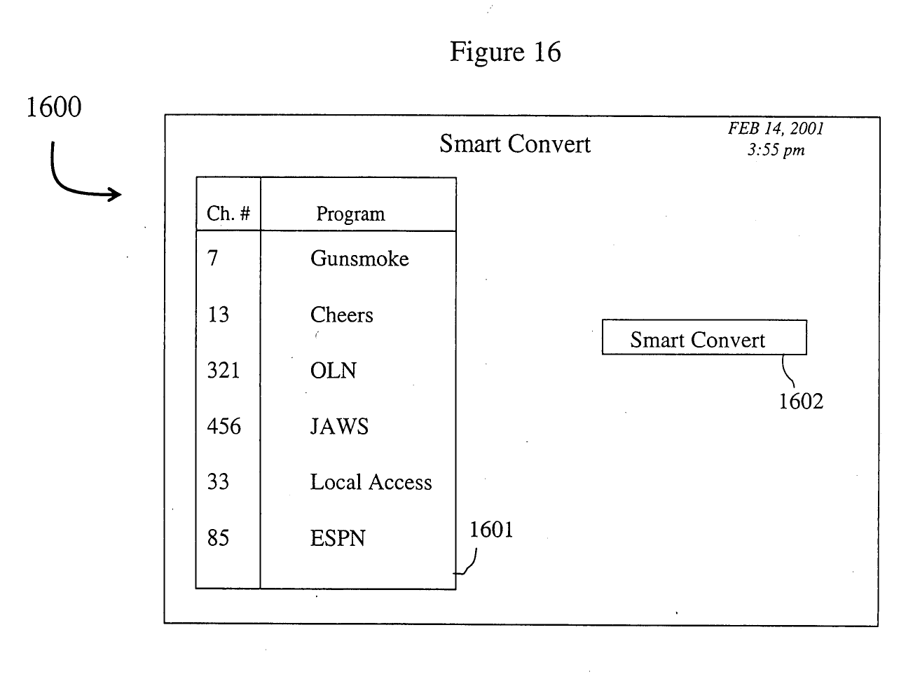

FIG. 16 illustrates an exemplary menu to quickly convert multiple cached programs to permanently recorded programs. In FIG. 16, a menu 1600 is displayed on display device 370, and may be entitled “smart convert”, for example. Along the left-hand side may be a tabular cell 1601 of programs that have been cached, here listed by channel and title. To select multiple programs for permanent recording, the user highlights (using scroll keys) those programs desired for permanent storage in HDD 320 for example. Then, the user selects the Smart Convert cell 1602, which thereafter displays a confirmation prompt (not shown) for the user to confirm their selection. After confirming, the selected content is permanently stored on HDD 320.

Moreover, another enhanced feature of the present invention is a record while pause feature, which offers the ability to record one program while pausing another program, where the paused content is cached in a suitable storage medium, such as SDRAM 315 for example. For example, if input port 325 receives two channel-tuned and demodulated signals, then simultaneous record while pause may occur. This feature permits a first channel (e.g. channel #1) to be recorded while viewing and/or pausing another channel (e.g. channel #2). In other words, the user may watch channel #1 (which may be automatically spooled or cached to SDRAM 315 or HDD 320 to enable the pause function) and simultaneously record channel #2.

Consistent with the normal recording function, recording of channel #1 commences with the push of a button, such as from remote control 400 or a record button on STB 300 itself. Recording may begin immediately and continue until stopped or the maximum capacity of HDD 320 allocated for recording application has been reached. It is envisioned that the maximum recording capacity of HDD 320 would be up to about at least 40 hours of recorded content with a 40 Gbyte storage capacity, but is only limited by the maximum size of the mass storage device.

In this record while pause mode, the transport processor 330 may perform simultaneous data decrypting and transport processing of two signals. In an exemplary embodiment, the two A/V elementary streams, are both routed to SDRAM 315 of the host processor 310 via the PCI bus 305. Under the control of the host processor 310, both streams may be transported. via bus 305 from the SDRAM 315 to be stored on the HDD 320. The paused channel may also be sent from the HDD 320 to a suitable output unit such as display device 370 via the PCI/IF 340 and decoder 350 (MPEG A/V decoder 352 and AC-3/MPEG Audio Decoder 356). The recorded channel can be different from the live broadcast (paused) channel. There may be three A/V streams when record while pause mode is executed, namely two input and one output A/V streams relative to the HDD 320.

Alternatively, the record while pause mode can be used to pause two live broadcasts simultaneously. The signal flow paths are as described above with the exception that one (or both) streams are sent from the HDD 320 to the display device 370 via the PCI/IF 340 and decoders 352, 356. If both streams are sent to the display device 370, then the display device 370 would preferably be equipped with the capability to display two programs (e.g. PIP (picture-in-picture), split screen or dual displays).

As a further alternative, the record while pause mode can be used to record two live broadcasts simultaneously. The signal flow paths are as described above with the exception that one (or both) streams are sent from the HDD 320 to the display device 370 via the PCI/IF 340 and decoders 352, 356. As above for multiple channel pause, if both streams are sent to the display device 370, then display device 370 would preferably be equipped with the capability to display two programs (e.g. PIP (picture-in-picture), split screen or dual displays).

The functionality of record while pause can also be generalized to more that two channels (e.g. N channels). To enable such extended functionality, the input port 325 should receive N tuned and demodulated channels. The data flow paths and control would be as described above, but the bandwidth and processors should be able to handle N simultaneous data streams. To provide such bandwidth, hardware elements could be duplicated. For example, multiple transport processors 330, PCI/IF devices 340 and decoders 352 and 356 could be provided to handle the demands imposed by recording and/or pausing N channels.

A further enhance feature in accordance with the invention is an undelete feature. The undelete feature permits users to recover recorded programs that have been previously designated to be deleted but which have not actually been purged (erased or permanently removed from storage). For example, a user, via a suitable user-interface such as remote control 400, can undelete a previously deleted recording.

This feature is available because when a user selects a recorded program to be deleted, the recording is not erased in HDD 320, so long as HDD 320 is not out of disk space. Additionally, on a displayed list of recorded programs on EPG 80 or on other menus, a program set for delete is not typically displayed. Alternatively, the user may display a list of program files flagged for deletion.

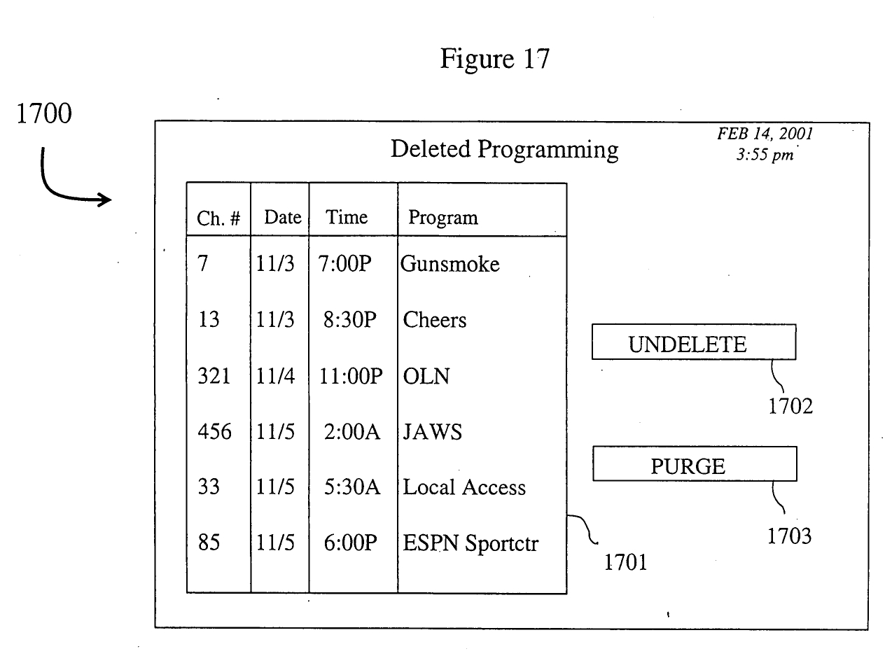

FIG. 17 illustrates an exemplary menu display for the undelete feature in accordance with the invention. As shown in FIG. 17, the user would bring up a menu screen 1700 (here entitled “Deleted Programming”) which has a tabular list of deleted programs in cell 1701.

The user simply highlights the desired deleted programs using scroll keys, and then selects the UNDELETE cell 1702 on menu 1700. Conversely, this menu also enables the user to purge (permanently delete) recorded programming using PURGE cell 1703, although preset system preferences and background processes purge the mass storage device (HDD 320) of programming designated for deletion after a period of time, which may be adjusted by the user. Selection of either the UNDELETE cell 1702 or PURGE cell 1703 automatically prompts a confirmation pop-up window for the user.

Yet another enhanced feature envisioned by the present invention is a DVR Play List. In this aspect, and from a selectable menu list of recorded programs on display device 370, a user selects multiple programs for playback by STB 300 via a user-interface such as remote control 400. The order of playback is preferably user-specified. Moreover, the DVR play list feature enables the ability to create, save, and edit multimedia play lists on STB 300.

Additionally, such an arrangement envisions the ability to enable the user to “chain” together segments of unrelated programs so that the user could chain together scenes from various movies or even songs from individual compact discs that are accessible from a CD player operatively connected to STB 300, in order to develop a desired play list of recorded multimedia programming. In an extreme example, this feature enables the user to even create his/her own “new” movie from pieces of recorded movies, utilizing the DVR Play list and A/V editing features previously described.

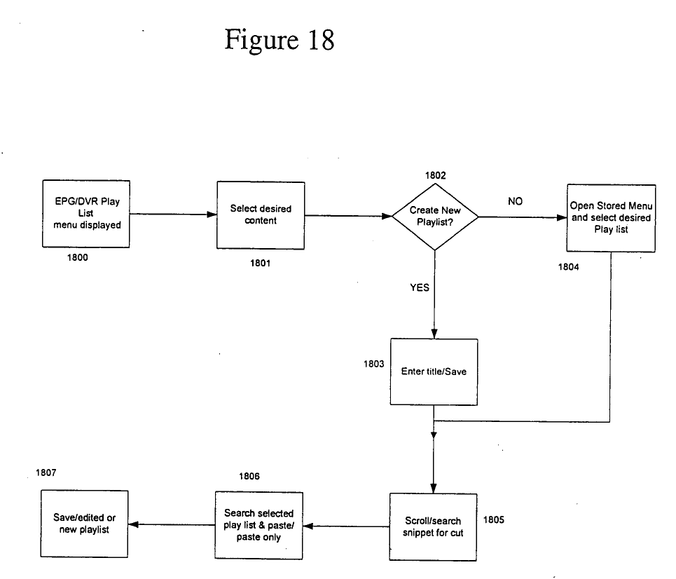

FIG. 18 illustrates a method of building and editing a DVR play list. The steps in FIG. 18 are somewhat similar to those describing the A/V editing feature above in FIG. 15.

Initially, the user may access EPG 80 to display selectable programs, together with or separate from a pop-up DVR Play List menu which includes a tabular listing of previously recorded or archived play lists (step 1800). Next, the user highlights a particular program, (step 1801) and selects an add to Play list option (step 1802). If the user has not specified a pre-recorded play list to edit, a prompt will query “Create new play list?”. If the user answers YES, a second query will ask for a title, so as to be saved and stored in HDD 320 (step 1803). If the user answers NO, and has not previously opened a saved play list to edit or amend a pop-up menu of stored play lists will be displayed so that the user may open the desired play list to edit (step 1804).

Once the play list has been opened, editing features follow what has been described using the A/V editing feature of FIG. 15. Specifically, step 1805 allows the user to scroll thru the selected, recorded program to search for a snippet to cut-and-paste. The user then selects an area within the play list in which to paste the snippet (step 1806). Once complete, the user saves the edited or new play list (step 1807) to a suitable mass storage device such as HDD 320. Preferably, recorded programming, cached programming, modified programming that is the result of cut-and-paste operations, and programming that has been subject to bookmarking (to be discussed further below) may be displayed as part of any new or modified play list.

Additionally, the sequence of items displayed in the DVR play list may of course be user defined and/or set as preferences. Further, the menu-driven features of the A/V editing and play list features enable chaining together segments of unrelated programs, so that user could chain together scenes from various programs, and create their own new program from pieces of recorded programs.

As noted above, instead of the snippet being A/V data or a frame of video, the snippet could be a recorded portion of a song on CD. Accordingly, the DVR Play list feature enables customized content to be created and edited by users for eventual display and viewing when access is desired.

Additionally, another menu driven feature provides a pop-up window that allows a user to perform a looping operation. This “loop snippet” feature enables the user to mark a starting and ending point in an A/V stream of recorded content, so that the data may be looped (i.e., displayed over and over on display device 370). The host processor (310) contains algorithms, software or processes therein that continually loop the marked data on display device 370, until terminated by the user, stored in HDD 320 or until a specified time has elapsed. Instead of a menu drive feature, the user, via suitable user interface, may be able to perform the loop snippet function while watching any recorded program, simply by pressing an action or execute button on remote control 400 for example.

Further, a menu driven feature provides a pop-up window that allows a user to insert multimedia “bookmarks”, (i.e. where did I stop watching a program). For example, via a GUI or remote control 400, a user can insert time bookmarks in live content that is recorded, or even post-recorded (i.e., during playback of recorded content). Once inserted, the user may jump between bookmarks simply by displaying a bookmark pop-up window that lists the bookmarks in a particular program. For example, a user places a bookmark at 23 minutes into a recorded program. Then the user shifts back to viewing live content or another recorded program.

Later, the user wants to go back to the program that was bookmarked, so he simply displays a bookmark menu, finds the desired program and highlights that program to see where (or if) bookmarks have been placed. Once he finds the desired bookmarks, he hits an execute button on the remote control 400 (or double clicks on an icon representing play program at bookmark on display device 370, for example), and the bookmarked program immediately begins playing at the 23 minute mark again.

Alternatively, each bookmark can represent a snippet of recorded material at that time, such as a specific play in a football game. When the user selects the bookmark, only the corresponding snippet is displayed. These snippets are automatically stored in HDD 320 or cached in SDRAM 315, and may preferably be indexed in a bookmark storage area that is accessible via a menu. Further the bookmark to be played may be A/V played back in real time or in one of several trick modes (i.e., fast forward, slow motion, frame-by-frame, reverse, etc.)

Moreover, the bookmarks may be annotated with labels or customized titles. A single program can have several annotated bookmarks therein. As an example, while watching a football game, a user may mark and annotate bookmarks for every touchdown or field goal scored in the game. Thereafter, he can scroll through each of the annotated bookmarks, conceivably labeled “TD1”, “TD2”, “FG1”, etc., thereby creating his or her own sports highlights feature. Further, bookmarks may be applied to cached and live programming, in addition to recorded programs.

STB 300 is provided with further enhanced features such as real-time HDD 320 capacity (Disk Gas Gauge), out-of-disk space alert and other file attributes. An icon-like Disk Gas Gage feature enables HDD 320 usage to be continuously updated and displayed to the user in real-time. As recording continues, the gauge creeps towards EMPTY. In another implementation, HDD 320 usage may be represented as a cylinder. Multiple colors may also be used to indicate the used and available HDD 320 space.

The Disk Gas Gauge feature indicates the percent of the HDD 320 consumed by recorded material, and may preferably be displayed numerically in conjunction with an icon or other uniquely shaped feature on a specified area of the video monitor. As an additional feature, as percent of HDD 320 consumed reaches lower levels, different video icons/shapes may be displayed to visually alert the viewer.

Another enhanced feature is a notification indicating the approximate minutes of recording time still available while recording is in progress. This out-of-disk space alert feature is preferably automatically displayed, when the remaining available recording time equals a predetermined default value. For example, the out-of-disk space alert may be displayed on display device 370 when there are thirty minutes of remaining available recording time. Alternatively, the out-of-disk space alert may be set to be displayed at various levels of remaining available recording time. This may be accomplished by the user selecting and displaying a sub-menu for setting out-of-disk space alerts. Additionally, the out-of-disk space alert may have both a video and audio component.

Additionally, coupled with these graphical features, the present invention envisions a plurality of other out-of-disk error handling scenarios such as starting to delete “delete-able” programming, automatically displaying error indications, etc. For example, if the program length is greater than the amount of unused HDD 320 space available, the user may receive a notification indicating such, as well as the recording time available, prior to or at the start of the recording.

The invention being thus described, it will be obvious that the same may be varied in many ways. For example, the functional blocks in FIGS. 1, 2 and 6-11 may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations. The computer executable program(s) may also be provided as part of externally supplied propagated signal(s). Such variations are not to be regarded as departure from the spirit and scope of the invention, and all such modifications as would be obvious to one skilled in the art are intended to be included within the scope of the following claims.

1. (canceled)

2. (canceled)

3. (canceled)

4. (canceled)

5. (canceled)

6. (canceled)

7. (canceled)

8. A method of recording content with a set top box (STB) while viewing current content received from a communication system, comprising:
issuing a first command to immediately record currently viewed content; said command sent from a user-interface to a processor in the STB; and
recording said currently viewed content on a mass storage device until said mass storage device runs out of storable space.

9. The method of claim 8, wherein said first and second commands are one-touch enabled features on a suitable user-interface such as a remote control, graphical user interface (GUI), or button on the STB.

10. The method of claim 8, wherein said first and second commands may be issued from a remote location.

11. The method of claim 8, wherein said currently viewed content can be recorded from a designated point forward, or from the beginning of a program.

12. A method of recording content, comprising the steps of:
displaying a preview channel of selectable content;
selecting at least one of the selectable content on the preview channel; and
recording said selected content once the selected content has been broadcast in its entirety.

13. The method of claim 12, wherein said selectable content on said preview channel represents a broadcast trailer of a full-featured broadcast of said selectable content.

14. The method of claim 12, wherein said selectable content on said preview channel represents a website trailer of a full-featured broadcast of said selectable content, the website being programmed in order to enable the user to activate program recording.

15. The method of claim 12, wherein said step of selecting includes selecting said content with a user-interface, said user-interface sending instructions to the STB to display a pop-up menu of selectable content.

16. The method of claim 15, wherein said user interface further enables the display of pop-up menus for recording conflict identification, finding alternate times and handling pay-per-view issues.

17. The method of claim 13, further comprising embedding triggers and other information in said broadcast trailer that inform the STB of the content to record.

18. A method of recording content with a set-top box (STB), comprising:
displaying a menu of selectable recorded programs;
selecting ones of the displayed programs for editing operations;
editing at least a part of the material in a selected programming in order to create a customized program for storage.

19. The method of claim 18, wherein said editing includes concatenation, truncation, frame capture, audio and video remix operations.

20. The method of claim 18, wherein said customized program is a video greeting card or outgoing message.

21. A method of recording content with a set-top box (STB), comprising:
caching live content continuously up until a point where a mass storage device operatively connected to the STB is full; and
thereafter displaying a menu of selectable cached content to be converted to permanently recorded content on the mass storage device.

22. The method of claim 21, wherein live content is viewable after changing channels, while the previously viewed content is being cached for potential permanent storage.

23. The method of claim 21, wherein said step of caching is user-selectable or automatically set as a default feature in the STB.

24. The method of claim 21, wherein the user can display an archived menu of cached live content from a specified period of time.

25. A method of recording content in a communication system receiving at least two channel signals, comprising: recording content of a first channel, and viewing content on a second channel, wherein the second channel is being viewed while the first channel is being recorded.

26. The method of claim 25, wherein said at least two channel signals are received by a set top box, said STB performing simultaneous data decrypting and transport processing of said at least two channel signals.

27. The method of claim 25, wherein the STB is configured to simultaneously pause received live content on both channels.

28. The method of claim 25, wherein the STB is configured to simultaneously record received live content on both channels.

29. The method of claim 25, wherein the STB is configured to simultaneously record or pause received live content on N channels, where N is the number of tuned and demodulated channels received by the STB.

30. A method of retrieving recorded content in a set-top box (STB), that has been designated as deletable, comprising:
displaying a menu of recorded programs that the user has designated as deletable from a mass storage device; and
selecting desired programs on said menu for un-deletion, wherein said selected programs are un-deleted so long as said mass storage device is not full.

31. The method of claim 30, further comprising selecting desired programs on said menu for permanent deletion from the mass storage device.

32. A method of creating a customized play list of content, comprising:
displaying a first menu of selectable content;
selecting content on said first menu;
displaying a second menu; and
adding said selected programs to said second menu.

33. The method of claim 32, wherein said first menu is an electronic program guide and said second menu is a stored archive of customized play lists which may be accessed and modified by a user with the selected content.

34. The method of claim 32, wherein said second menu is the customized play list, and displays selected items that are user configurable.

35. A method of looping recorded content in a set-top box (STB), comprising:
marking a start point and an end point of currently viewed content; and
subjecting the marked data to a looping operation so that it is continually looped on a display device operatively connected to the STB.

36. The method of claim 35, wherein said looping operation may be effected via a menu-driven display or via a suitable user-interface.

37. The method of claim 35, wherein the marked data is real-time data or trick mode data.

38. A method of marking desired points in a program for viewing, comprising:
inserting a marker at a point in currently viewed content, said marker representing a bookmark snippet of the content; and
storing the bookmark, wherein a user may display the bookmark via a user interface.

39. The method of claim 38, wherein the user can view other programming and jump back to the bookmarked content and resume viewing.

40. The method of claim 38, wherein the user annotates the bookmarks.

41. The method of claim 38, further comprising displaying a menu of stored bookmarks.

42. The method of claim 38, wherein said currently viewed content is live, recorded or cached programming.

43. A digital video recording (DVR) apparatus in a communication system comprising:
a memory for storing a plurality of selectable parameters related to recording of content in the DVR apparatus;
a processor for displaying a menu of said selectable parameters; and
a user interface device for selecting at least one parameter from the menu in order to effect a recording operation for the content.

44. The DVR apparatus of claim 43, wherein said user-interface is selected from the group comprising a remote control, graphical user interface (GUI), function button on the DVR, external keyboard or an external personal computer (PC) operatively connected to the DVR.

45. The DVR apparatus of claim 43, wherein one of the selectable parameters is a disk gas gage feature indicating how much of a mass storage device operatively connected to the DVR is consumed by recorded material.

46. The DVR apparatus of claim 45, wherein said disk gas gage provides a percent of storage available of remaining in real-time.

47. The DVR apparatus of claim 43, wherein one of the selectable parameters is a notification indicating the approximate minutes of recording time still available while recording is in progress.

48. The DVR apparatus of claim 47, said notification embodied as an out-of-disk space alert feature which is automatically displayed when the remaining available recording time equals a predetermined default value.

49. The DVR apparatus of claim 48, wherein said out-of-disk space alert feature is configured to have both audio and video components.

50. An apparatus for recording content with a set top box while viewing current content received from a communication system, comprising:
a control device to issue a first command to immediately record currently viewed content;
a processor to receive the first command and to record said currently viewed content on a mass storage device until said mass storage device runs out of storable space.

51. An apparatus as defined in claim 50, wherein the control device is implemented by a one-touch enabled features on a remote control.

52. An apparatus as defined in claim 50, wherein the control device is implemented by a graphical user interface (GUI).

53. An apparatus as defined in claim 50, wherein the control device is implemented by a button on the set top box.

54. The method of claim 50, wherein said first and second commands may be issued from a remote location.

55. The method of claim 50, wherein said currently viewed content can be recorded from a designated point forward, or from the beginning of a program.
